(19) United States
(12) Patent Application Publication
(10) Pub. No.: US 2016/0090288 A1
(43) Pub. Date: Mar. 31, 2016

(54) Automated Mixed Drink Dispenser

(71) Applicant: Monsieur LLC, Atlanta, GA (US)

(72) Inventors: Barry Maurice Givens, JR., Atlanta, GA (US); Eric Joseph Williams, JR., Atlanta, GA (US); Paul Qantas Judge, Atlanta, GA (US); Donald Oneal Beamer, JR., Atlanta, GA (US); Mario Lyndell Taylor, II, Marietta, GA (US)

(73) Assignee: MONSIEUR LLC, Atlanta, GA (US)

(21) Appl. No.: 14/868,317

(22) Filed: Sep. 28, 2015

Related U.S. Application Data
(60) Provisional application No. 62/056,863, filed on Sep. 29, 2014.

(51) Int. Cl. B67D 1/08; G05B 15/02

(52) U.S. Cl. CPC B67D 1/0888; G05B 15/02

(57) ABSTRACT

This disclosure relates generally to beverage dispensing systems. In one embodiment, device for dispensing a beverage includes a housing and a beverage dispensing control system. The housing may include a plurality of reservoirs each respectively configured to contain a respective liquid ingredient, a plurality of pump mechanisms, wherein each pump in the plurality of pump mechanisms is operatively connected to a respective reservoir from the plurality of reservoirs, and configured to transfer the respective liquid ingredient from the respective reservoir. The housing may further include a nozzle operatively connected to the plurality of pump mechanisms, configured to receive a liquid ingredient from at least one pump mechanism from the plurality of pump mechanism, and dispense the liquid ingredient into a beverage receptacle, a solid ingredient reservoir, a solid ingredient dispensing mechanism, an age gateway module, and an intoxication gateway module.

### CROSS-REFERENCE TO RELATED APPLICATIONS

This application claims the benefit of U.S. Provisional Application No. 62/056,863, filed Sep. 29, 2014, which is hereby incorporated by reference in its entirety.

### TECHNICAL FIELD

This disclosure relates generally to beverage dispensing systems, and more particularly, to a system, method, and apparatus for automatic beverage dispensing.

### BACKGROUND

Creating custom cocktails (mixed drinks) may be time consuming, messy, and inconsistent, depending on the skill of the individual tending the bar. Businesses that sell mixed beverages depend on human factors to maintain quality, and prepare beverages quickly. For example, if too much of an expensive ingredient is served with respect to the price paid, profitability may decline. If too little ingredient is served, beverage quality may decline, and customers may leave unsatisfied. Moreover, patrons of an establishment may desire consistently prepared beverages, ordered conveniently, and prepared quickly.

Bar owners, event hosts, home users, and many others may benefit from systems, methods and apparatuses configured to automatically prepare and dispense a variety of mixed beverages, without human error and minimum human interaction. Further, people may desire to share information with each other regarding the types of drinks they are ordering via social media, and share drink recipes. Furthermore, retail establishment owners and the like may need to manage multiple automatic beverage dispensers from a central control platform.

### SUMMARY

Before embodiments of the present systems and methods are described, it is to be understood that this disclosure is not limited to the particular platforms, systems, and methods described, as there can be multiple possible embodiments of the present disclosure which are not expressly illustrated in the present disclosures. It is also to be understood that the terminology used in the description is for the purpose of describing the particular versions or embodiments only, and is not intended to limit the scope of the present disclosure.

In one embodiment, a device for dispensing a beverage is described. The dispenser may include a housing and a beverage dispensing control system. The housing may include a plurality of reservoirs each respectively configured to contain a respective liquid ingredient. The housing may further include a plurality of pump mechanisms, where each pump in the plurality of pump mechanisms is operatively connected to a respective reservoir from the plurality of reservoirs, and configured to transfer the respective liquid ingredient from the respective reservoir. The housing may further include a nozzle operatively connected to the plurality of pump mechanisms, configured to receive a liquid ingredient from at least one pump mechanism from the plurality of pump mechanism, and dispense the liquid ingredient into a beverage receptacle. A solid ingredient reservoir configured to contain one or more solid ingredient and further configured to maintain the one or more solid ingredient at a pre-determined temperature until dispensed may be further included. The housing may also include a solid ingredient dispensing mechanism configured to dispense the one or more solid ingredient, an age gateway module, and an intoxication gateway module. The beverage dispensing device controller may include a processor, and a non-transitory computer-readable storage medium disposed in communication with the processor and storing processor-executable instructions. The instructions may be configured to, when executed, cause the processor to acquire, via a transponder, data comprising instructions for preparing a plurality of beverages associated with a pre-determined theme. The instructions may also cause the processor to receive, via an input device, instructions to prepare a beverage, and verify, via the age gateway module, an age of a user. The instructions may further cause the processor to verify, via the intoxication gateway module, an intoxication status of a user. When both of a pre-determined age, and intoxication criteria are satisfied, the instructions may cause the beverage dispenser to prepare a beverage. Accordingly, the beverage dispenser may detect, via a proximity sensor, whether a beverage receptacle is present, and when the beverage receptacle is present, transmit, to a first pump mechanism from the plurality of pump mechanisms, instructions to pump a first liquid ingredient associated with the first pump mechanism to the nozzle at a first flow velocity. The processer may further transmit, to a second pump mechanism from the plurality of pump mechanisms, instructions to pump a second liquid ingredient associated with the second pump mechanism to the nozzle, at a second flow velocity, dispense, via the solid ingredient dispensing mechanism, the one or more solid ingredients into the beverage receptacle, and output, via an output device, an indication that the beverage is complete.

In another embodiment, a non-transitory computer-readable medium is disclosed. The computer-readable medium may store instructions, that when executed, cause one or more processors to receive, via a transceiver, data indicating a remote device status of the at least one remote device for dispensing a beverage, transmit, via the transceiver, instructions that cause the remote device to perform one or more of: modify the types of beverages servable by the remote device, display a pre-determined message via an output device operatively connected to the remote device, and perform a pre-determined shut-down procedure of the remote device.

In yet another embodiment a system for distributing beverage recipes is disclosed. The system may comprise a non-transitory computer-readable storage medium storing software instructions configured to, when executed, cause one or more processors to perform one or more of beverage recipe sharing operations and push advertising operations. Beverage recipe sharing operations comprises authenticating a first user client device, receiving, from the authenticated first user client device, instructions for preparing a custom beverage from one or more of the first user client device and the first device for dispensing a beverage, storing the instructions on the non-transitory computer-readable storage medium, and transmitting, via a transceiver, the instructions for preparing the custom beverage to one or more of a remote second user client device and a second device for dispensing a beverage based on a pre-determined transmission criterion. Push advertising operations comprises: authenticating a remote first user client device, authenticating a remote first device for dispensing a beverage, and transmitting, to the first user client device instructions for displaying, on the first device for dispensing a beverage, a pre-determined advertising message.

It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates an exemplary beverage dispenser according to some one embodiment.

FIG. 1B is a front view of an exemplary beverage dispenser according to another embodiment.

FIG. 1C is a perspective view of the exemplary beverage dispenser of FIG. 1B.

FIG. 2 is a functional block diagram of an exemplary beverage dispenser system according to some embodiments.

FIG. 3 is a flow diagram illustrating an exemplary setup of the dispenser of FIG. 1 in accordance with some embodiments.

FIG. 4 is a flow diagram illustrating exemplary steps for ordering a beverage using the dispenser of FIG. 1 in accordance with some embodiments.

FIG. 5 is a flow diagram illustrating a method for providing a beverage suggestion in accordance with some embodiments.

FIG. 6 is a flow diagram illustrating a method for accessing beverage recipes from another dispenser in accordance with some embodiments.

FIG. 7A is a flow diagram illustrating a method of remotely managing a beverage dispenser in accordance with some embodiments.

FIG. 7B illustrates an exemplary user interface used in the method of 7A in accordance with some embodiments.

FIG. 7C illustrates an exemplary user interface used in the method of 7A in accordance with some embodiments.

FIG. 7D Illustrates an exemplary user interface used in the method of 7A accordance with some embodiments.

FIG. 8 is a flow diagram illustrating a method of beverage preparation in accordance with some embodiments.

FIG. 9A is a flow diagram illustrating a method of acquiring beverage theme data in accordance with some embodiments.

FIG. 9B illustrates an exemplary user interface for acquiring beverage theme data in accordance with some embodiments.

FIG. 9C illustrates an exemplary user interface for acquiring beverage theme data in accordance with some embodiments.

FIG. 10 is a flow diagram illustrating a method for verifying intoxication status in accordance with some embodiments.

FIG. 11 is a flow diagram illustrating a method for automatic beverage layering in accordance with some embodiments.

FIG. 12 is a flow diagram illustrating a method for sharing beverage dispenser recipes in accordance with some embodiments.

FIG. 13 is a flow diagram illustrating a method for delivering multimedia content in accordance with some embodiments.

FIG. 14 illustrates an exemplary user interface used in a beverage ordering system in accordance with some embodiments.

FIG. 15 illustrates an exemplary user interface used in a beverage ordering system in accordance with some embodiments.

FIG. 16 illustrates an exemplary user interface used in a beverage ordering system in accordance with some embodiments.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Illustrative embodiments of the present disclosure are listed below.

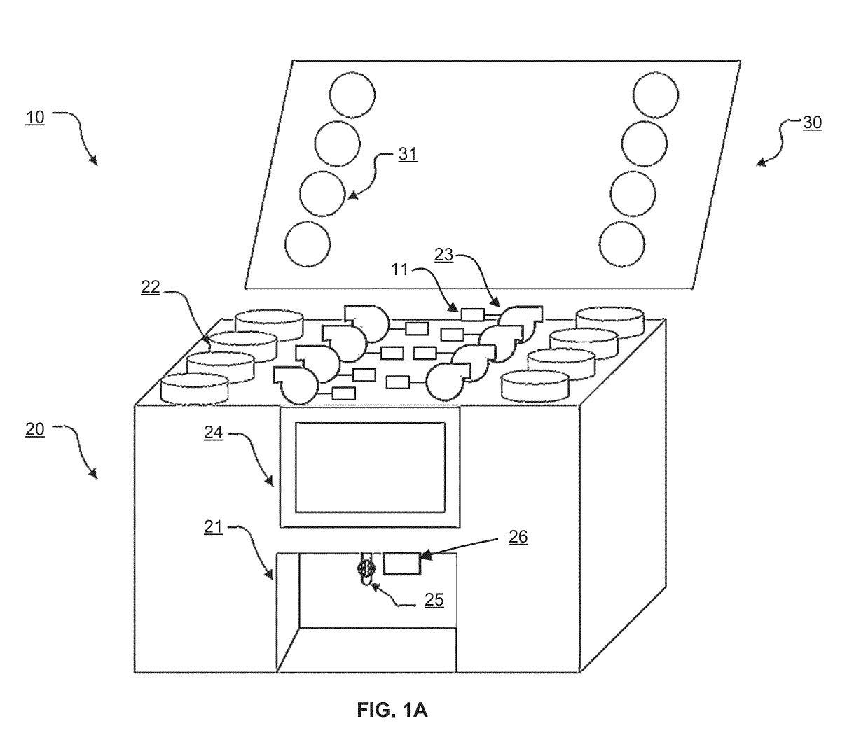

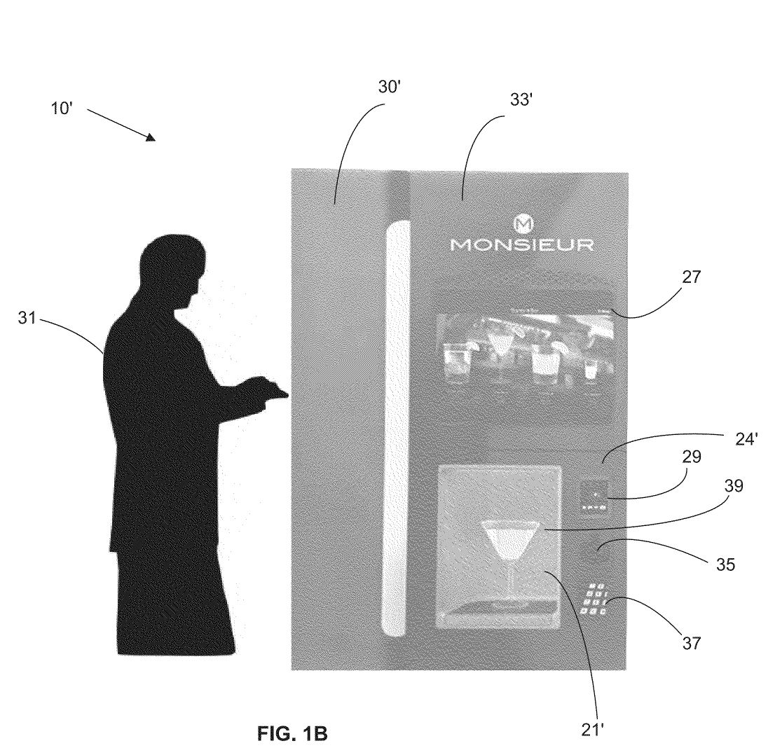

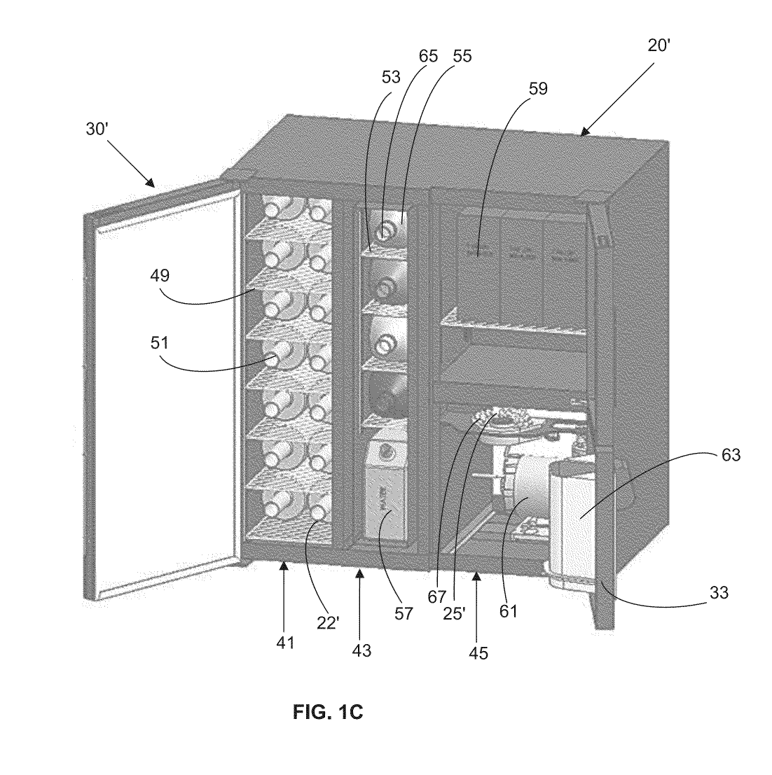

FIG. 1A depicts a beverage dispenser 10, according to one embodiment. Dispenser 10 may be configured to hold a plurality of liquid and/or solid ingredients in reservoir(s) 22. Reservoirs 22 may be configured to receive one or more bottles containing one or more liquid ingredients. For convenience, subsequent portions of this description will refer to any combination of those ingredients or any single consumable ingredient collectively as a “drink” or a “beverage.”

In some embodiments, the dispenser 10 may be portable in nature and may generally be placed on a table or countertop. In some embodiments, the dispenser 10 may be portable such that it may be moved from one location to another without the use of machinery (e.g., via one user, two users, or a plurality of users relocating the machine). In other embodiments, the dispenser 10 may be portable because the weight of the dispenser 10 is less than 100 lbs. In other embodiments, the dispenser 10 may be portable due to its capability to be self-operational in a variety of locations. That is, in some embodiments, the portable dispenser 10 may be capable of operating proximate to a power source but without any additional external connections to the dispenser 10. Further, the dispenser 10 may be fabricated from one or more materials, including polycarbonates, ceramics, metals, plastics, etc.

In other embodiments, the dispenser 10 may be configured as a fixed, non-portable device. For instance, the dispenser 10 may be non-portable due to its weight requiring the use of machinery to relocate the device from one location to another. For further example, a non-portable weight may be a weight greater than 120 lbs without liquid and solid ingredients, or greater than approximately 160 lbs with liquid and solid ingredients. In other embodiments, the dispenser 10 may be non-portable due to its need to connect to one or more external connections other than only a power source.

Various components of dispenser 10 are contained within a housing 20 and a removable top 30. According to some embodiments, a sealable top 30 is provided. According to yet other embodiments, the top is configured to be open and receive bottles containing liquid ingredients. According to one exemplary embodiment, reservoirs 22 may be configured to receive a bottle situated where the open top of the bottle is pointed down into the reservoir, and the reservoir contains a sealing ring that securely seals around the top portion of the upside-down bottle. The reservoirs 22 may each be coupled to one or more corresponding pumps 23, and associated with a circuit board 11. In some embodiments, each combination of one or more pumps 23 and the circuit board 11 associated therewith may form a pump module. Each pump module may be configured to be removed and replaced either in whole or in part. For example, in one embodiment, one or more of the reservoirs 22 may be reconfigured to hold wine, and the pump modules may be replaced with wine preservation modules coupled to the circuit boards 11 and configured to, for example, provide argon gas to preserve or dislodge the wine in the reservoirs 22.

Housing 20 may include a display/input device 24, a recess 21 and a nozzle 25 located within recess 21. Housing 20 may also include a solid ingredient dispenser 26. Solid ingredient dispenser 26 may be configured to receive one or more solid ingredients from one or more reservoirs 22 configured to hold solid ingredients. Solid ingredients may be, for example, pickled olives or onions, cherries, citrus wedges, ice, etc.

Housing 20 may also include one or more sensors (not shown) configured to detect the presence and approximate size of a beverage receptacle (e.g., a cup) placed in recess 21. The sensor(s) described herein may be one sensor or a plurality of sensors. Accordingly, the sensor(s) may include a sensor configured to detect the presence of a beverage receptacle, detect the presence of a bottle or liquid ingredient, detect the presence of a solid ingredient, etc. According to one aspect, the sensor(s) may detect the presence of a beverage receptacle, detect one or more dimensions of the receptacle, and transmit the information to a processor (not shown in FIG. 1). Accordingly, the processor may approximate a volume of the beverage receptacle placed in the recess 21, and a beverage may be prepared by dispenser 10 using the volume information to proportion the respective liquid ingredients.

Dispenser 10 may also include a backsplash and a drain pan assembly (not shown), which may be configured to fit within recess 21. Spillage and drips from nozzle 25 may fall through the spaces of a grill (not shown) into a drain pan assembly and may be funneled into a drain tube (also not shown) for disposal.

The display/input device 24 may include a main display area configured as a touch screen, and/or include one or more user-actuatable buttons that may be actuated to initiate various operations of dispenser 10. For example, display/input device 24 may include a button that may be actuated by a user to select a beverage or to begin flow of one or more liquid ingredients from nozzle 25. As another example, display/input device 24 might include a touch screen interface configured to display virtual buttons that are user-actuatable for performing administrative tasks, such as, for example, initial set up, ingredient selection, etc.

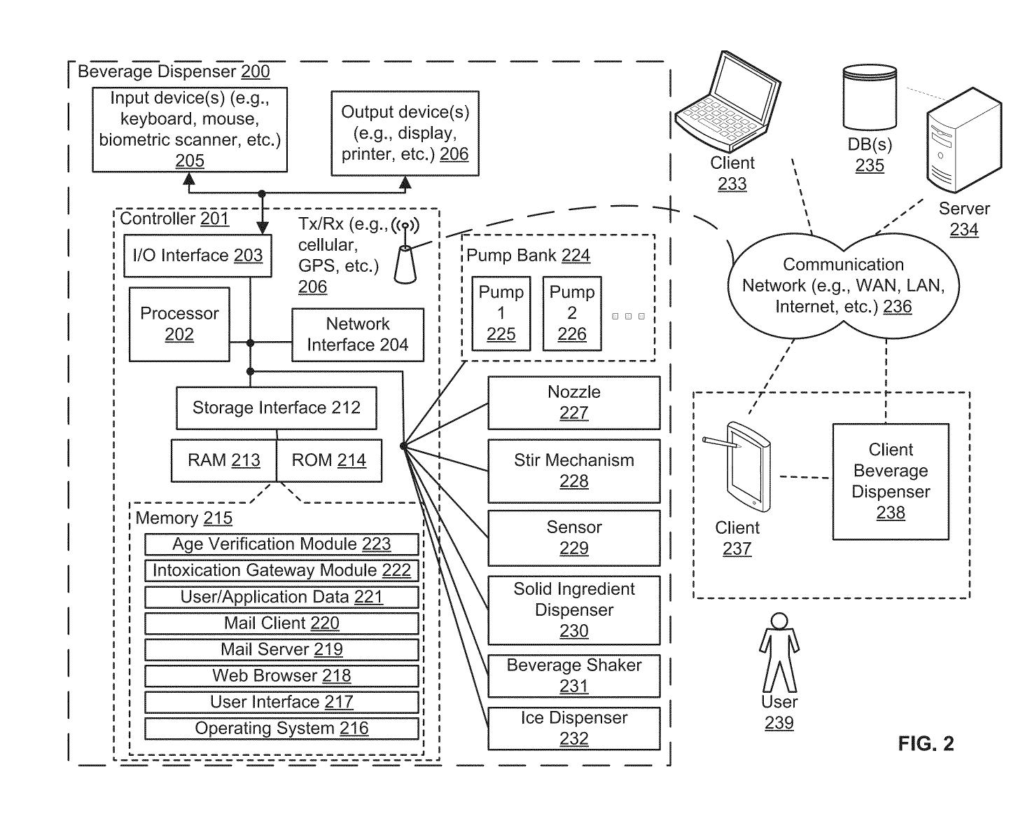

Generally, dispenser 10 includes a pump bank (224 as shown in FIG. 2) and the open ends of a number of ingredient reservoir(s) 22. Pump bank 224 may include a plurality of individual pump mechanisms. Any one or more pump mechanism in pump bank 224 may be operatively connected with a respective one or more reservoir(s) 22, and configured to receive one or more liquid ingredients from a corresponding one or more reservoir(s) 22. Each pump mechanism in pump bank 224 may include a variable speed pump mechanism. For example, pump bank 224 may include one or more peristaltic pumps, or other type of pump configured to transfer liquid ingredients at a controllable rate. Reservoir(s) 22 may be manufactured from a variety of materials suitable for containing consumer-grade liquids, for example, glass, plastic, paper or a bag-in-a-box (BIB), etc. Although not shown, beverage dispenser 10 includes a connection to a power supply (e.g., 120V AC power, rechargeable battery, etc.).

A controller, discussed in more detail with respect to FIG. 2, may be configured to store flow velocity data indicating the velocity each pump mechanism in pump bank 224 should pump when dispensing a selected liquid ingredient. In response to a signal from the input device 24, and based on its stored data, the controller may send an instruction to a pump to dispense an ingredient from reservoir(s) 22. For example, input device 24 may receive an instruction to prepare a beverage requiring the dispensing of two ingredients from reservoir(s) 22. If the selected beverage is comprised of two or more liquid ingredients, one ingredient may be required in a different proportion than the other ingredient. For example, if the selected beverage has ingredient A at a ratio of 2:1 with respect to ingredient B, dispenser 10 may be configured to dispense two ounces of ingredient A and one ounce of ingredient B.

According to one aspect, the ingredients may be dispensed simultaneously. According to yet another aspect, the liquid ingredients may be dispensed sequentially, according to a beverage recipe. Pump bank 224 may also include pumps configured to incrementally dispense ingredients in measured amounts based on the dispensed volume rather than at a particular flow rate, as described above, without departing from the scope of the present disclosure.

According to one embodiment, removable top 30 may include one or more sealing mechanisms 31 configured to seal the reservoirs within dispenser 10. When the removable top 30 is placed on the housing 20, the sealing mechanism 31 may be positioned to contact each open end of reservoir(s) 22. The contact between the sealing mechanism 31 and each reservoir(s) 22 may provide a seal sufficient to prevent contamination, prevent spillage, and/or preserve the integrity of the ingredients contained in each reservoir(s) 22. The sealing mechanism 31 may be a silicone type or other food-safe material. Sealing mechanism 31 may be configured to individually seal each reservoir(s) 22. According to embodiments, sealing mechanism 31 may be configured to seal the periphery of top 30.

FIGS. 1B and 1C are front and perspective views, respectively, of another embodiment of a beverage dispenser 10′. The beverage dispenser 10′ is configured in a vertical configuration as compared to the horizontal configuration depicted in the embodiment of FIG. 1A. However, it should be noted that the particular configuration of the beverage dispenser 10, 10′ may be subject to a variety of implementation-specific variations, not limited to those shown in FIGS. 1A-C. For example, if the given implementation requires that the beverage dispenser 10, 10′ fit into a predetermined space (e.g., a predetermined height, width, and/or depth), the components of the dispenser 10, 10′ may be rearranged, reordered, and/or resized to accommodate the space constraints.

For further example, in some embodiments, the quantity of one or more of the components of the beverage dispenser 10, 10′ may be varied to meet implementation-specific limitations. For example, in embodiments where portability is desired, a fewer number of, for example, reservoirs 22, pumps 23, or any other component, may be provided. Indeed, the configuration of the beverage dispenser 10, 10′ is subject to a variety of implementation or user specific variations.

In the embodiment shown in FIGS. 1B and 1C, the beverage dispenser 10′ includes a front panel 30′ configured to separate a variety of internal components from a user 31. The beverage dispenser 10′ also includes a user interface panel 33 configured to enable interaction between the user 31 and the beverage dispenser 10′. The user interface panel 33 includes a plurality of user input devices 24′. In the illustrated embodiment, the plurality of user input devices 24′ include a touchscreen panel 27, a user-data collection device 29, a user-device reader 35, and a manual input device 37. However, the illustrated user input devices 24′ are merely examples. In other embodiments, more or fewer devices of any desired type may be provided.

In the depicted embodiment, the touchscreen panel 27 enables the user 31 to interact with the dispenser 10′ via touching the touchscreen panel 27. For example, the user 31 may touch the touchscreen panel 27 to select a type of the beverage (e.g., a margarita, martini, flavored drink, etc.) to be prepared by the dispenser 10′.

The user-data collection device 29 may be configured to acquire data specific to the user 31. For example, the user-data collection device 29 may be a digital recording device, such as a camera, configured to acquire a digital image of some or all of the user 31. In other embodiments, the user-data collection device 29 may be a radio-frequency identification (RFID) reader configured to read an RFID tag located, for example, on the user 31 or an item associated with the user 31. For example, in one embodiment, the dispenser 10′ may be located in a retail establishment and the an identification card of the user 31 may be reviewed prior to admitting the user 31 to the retail establishment. Upon entry, the user 31 may be given a device, such as a wristband having a RFID tag integrated therein.

In other embodiments, the user-data collection device 29 may be configured as a scanner configured to read an image or code located on a mobile device (e.g., a cell phone, tablet, etc.) associated with the user 31. In still further embodiments, the user-data collection device 29 may be a touch sensitive detection device, such as a fingerprint reader.

The user-device reader 35 may be a reader configured to read a code, imprint, magnetic strip, etc. on a device associated with the user 31. For example, the user-device reader 35 may be configured to read a barcode or magnetic strip located on the user's identification card. Further, in some embodiments, the user-device reader 35 may be configured to read a chip, such as a chip located in a user's credit card or identification card.

The manual input device 37 may be configured as any type of device capable of receiving manual input from the user 31. For example, the manual input device 37 may be a keyboard through which the user 31 may input information, such as a pin associated with a chip read by the user-device reader 35.

In some embodiments, the dispenser 30′ may be configured to utilize one or more inputs from the plurality of user input devices 24′ to verify the user 31 before dispensing a beverage 39 into recess 21′ for the user 31. For example, in some embodiments, the user's mobile device may be scanned by the user-data collection device 29 to verify that the user associated with the mobile device is over an age threshold. The user 31 may then input a second piece of information, such as a thumbprint, or the dispenser 10′ may acquire the second piece of information, such as a digital image of the user 31, to verify that the user associated with the scanned mobile device is the user 31. For further example, in one embodiment, the dispenser 10′ may acquire first information via scanning of an identification card in the user-device reader 35 and second information in the form of a thumbprint or acquired digital image of the user 31 to perform the verification.

FIG. 1C illustrates internal components of the dispenser 10′ in accordance with one embodiment. In this embodiment, housing 20′ of the dispenser 10′ is configured such that the front panel 30′ and the user interface panel 33 may be opened. A plurality of modules 41, 43, and 45 are located internal to the housing 20′ and are each configured to house one or more internal components and separate the housed components from the components of the other modules. For example, each of the plurality of modules 41, 43, and 45 may be configured to maintain a desired temperature within that module, and the temperatures of each of the modules may differ. Further, in some embodiments, the temperatures at which the modules 41, 43, and 45 are maintained may be selectively controlled by an operator or automated control system. Indeed, the plurality of modules 41, 43, and 45 may differ in configuration in different embodiments, depending on implementation-specific considerations.

In the illustrated embodiment, a first module 41 houses a plurality of containers 51 positioned horizontally on a plurality of shelves 49 that support the plurality of containers 51. In some embodiments, the containers 51 may contain a plurality of types of liquor that may be included inn a beverage. The first module 41 may be maintained at room temperature in some embodiments, or at a colder or warmer temperature, depending on the type of liquid in containers 51.

A second module 43 houses a plurality of refillable containers 55 positioned horizontally on a plurality of shelves 53 that support the refillable containers 55. In some embodiments, each of the refillable containers 55 may include a cap 65 configured to be removed from the refillable containers 55 to enable cleaning and/or refilling of the containers 55. Further, the cap 65 may include a quick connector positioned thereon.

The second module 43 also houses a liquid (e.g., water) tank 57 to enable the second module 43 to be refrigerated, if desired. For example, in some embodiments, the plurality of refillable containers 55 may be filled with fresh liquids, such as lime juice, lemon juice, tomato juice, orange juice, or other liquids for which refrigeration is desired. The ability to maintain refrigeration in a selected portion of the housing 20′, i.e., module 43, may offer one or more advantages over systems in which all the non-alcoholic mixers are selected to be BIB and, thus, are maintained at room temperature. For example, the refrigeration capabilities and refillable containers 55 enable fresh ingredients to be used.

A third module 45 houses a plurality of BIB mixes 59, a nozzle 25′, a carbonation tank 61, and a recessed cup compartment 63. The nozzle 25′ includes a plurality of sub-nozzles 67. Each sub-nozzle 67 defines a separate passageway configured to receive only one ingredient to be dispensed such that the dispensed ingredients (including both the alcoholic and non-alcoholic ingredients) are not mixed until reaching the container for beverage 39. Further, in some embodiments, the rate of flow of each of the ingredients through each of the plurality of sub-nozzles 67 may be selectively controlled to control the mixing of the ingredients being dispensed from the nozzle 25′ through separate passageways into the container for beverage 39.

FIG. 2 depicts an exemplary beverage dispenser system according to embodiments of the present disclosure. Variations of controller 201 may be used for implementing client 233, server 234, databases 235, and client 237. Controller 201 may comprise a central processing unit (“CPU” or “processor”) 202. Processor 202 may comprise at least one data processor for executing program components for executing user- or system-generated requests. A user 239 may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor Error! Reference source not found. 202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 202 may be disposed in communication with one or more input/output (I/O) devices via I/O interface 203. The I/O interface 203 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc. Controller 201 may include a voice recognition system configured to listen for the presence of verbal commands (voice recognition). Accordingly, a user's previously recognized voice may be used an input may be provided to processor 202 (as shown in FIG. 2) for carrying out specific actions, such as ordering a beverage.

Using the I/O interface 203, the controller 201 may communicate with one or more I/O devices. For example, the input device 206 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 205 may be a printer, fax machine, video display (e.g., cathode ray tube (CRT), liquid crystal display (LCD), light-emitting diode (LED), plasma, or the like), audio speaker, etc. In some embodiments, a transceiver 206 may be disposed in connection with the processor 202. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/30/40/4gLTE/5G HSDPA/HSUPA communications, etc.

In some embodiments, the processor 202 may be disposed in communication with a communication network 236 via a network interface 204. The network interface 204 may communicate with the communication network 236. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 236 may include, without limitation, a direct interconnection, local area network (LAN), wide area network (WAN), wireless network (e.g., using Wireless Application Protocol), the Internet, etc. Using the network interface 206 and the communication network 236, the controller 201 may communicate with devices 233, 234, and 237. These devices may include, without limitation, personal computer(s), server(s), fax machines, printers, scanners, various mobile devices such as cellular telephones, smartphones (e.g., Apple iPhone, BlackBerry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the controller 201 may itself embody one or more of these devices. The controller 201 may also communicate with client beverage dispenser 238. According to some embodiments, client beverage dispenser 238 may be in direct communication (via wired or wireless communication) with one or more client devices, e.g., client 237.

In some embodiments, the processor 202 may be disposed in communication with one or more memory devices (e.g., RAM 213, ROM 214, etc.) via a storage interface 212. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small controllers interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, database 235.

The memory devices may store a collection of program or database components, including, without limitation, an operating system 216, user interface application 217, web browser 218, mail server 219, mail client 220, user/application data 221 (e.g., any data variables or data records discussed in this disclosure), intoxication gateway module 222, age verification module 223, a voice recognition engine, etc. The operating system 216 may facilitate resource management and operation of the controller 201. Examples of operating systems may include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, and/or the like. Input device 205 and output device 206 may facilitate display, execution, interaction, manipulation, or operation of program components through textual or graphical facilities. For example, user interfaces may provide computer interaction interface elements on a display system operatively connected to the controller 201, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like. According to some embodiments, input device 205 and output device 206 may be a unified device, such as, for example, a touch screen and/or the like.

In some embodiments, the controller 201 may implement a web browser 218 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the controller 201 may implement a mail server 219 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the controller 201 may implement a mail client 220 stored program component. The mail client may be a mail viewing application, such as Apple Mail, Microsoft Entourage, Microsoft Outlook, Mozilla Thunderbird, etc.

In some embodiments, controller 201 may store user/application data 221, such as the data, variables, records, etc. (e.g., beverage data, a beverage suggestion data, user profile data, etc.) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various controllers discussed above in this disclosure. It is to be understood that the structure and operation of any computer or database component may be combined, consolidated, or distributed in any working combination.

Furthermore, one or more non-transient computer-readable storage media may be utilized in implementing embodiments consistent with the present disclosure. A non-transitory computer-readable storage medium refers to any type of physical memory on which information or data readable by a processor may be stored. Thus, a non-transitory computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Controller 201 may be configured to power and/or control nozzle 227, stir mechanism 228, sensor 229, solid ingredient dispenser 230, beverage shaker 231, and ice dispenser 232. Controller 201 may also be configured to power and control pumps 225 and 226 of pump bank 224. Each pump in the plurality of pump mechanisms is operatively connected to a respective reservoir 22, and configured to transfer a liquid ingredient from the respective reservoir 22 to nozzle 25. In response to control signals and/or power from controller 201, each pumping mechanism may transfer a liquid ingredient from a respective reservoir 22 to nozzle 25 via one or more operatively connected tubes (not shown). Beverage dispenser 200 may also include one or more temperature control mechanisms configured to maintain a predetermined temperature in one or more reservoirs (not shown).

Each reservoir(s) 22 may be operatively connected to one or more sensors 229. Sensor 229 may be a proximity indicator, e.g., a liquid level sensor, or solid material sensor, RFID (radio frequency ID) readers, bar code scanners, OCR (optical character recognition) scanners, etc. Sensor 229 may periodically transmit data to processor 202 indicating the measured ingredient level in each reservoir(s) 22. If the ingredient level is below a certain threshold, processor 202 may provide instructions to output device 206 to display an appropriate message indicating a low ingredient level. Processor 202 may also initiate instructions to transmit a text message (SMS message and/or the like) to a predetermined user of the dispenser 10, where the message includes an indication of the ingredient levels.

User application data 221 may include a beverage suggestion engine. The beverage suggestion engine may be configured to provide a user with a listing of beverages suggested based on a previously stored, and/or newly created profile data. More particularly, the beverage suggestion engine may be configured to utilize stored profile data to provide a listing of beverages to user 239 based on available ingredients stored in reservoir(s) 22. The beverage suggestion engine may suggest beverages with similar characteristics to beverages previously ordered by a particular user, for example, user 239. Processor 201 may determine which drinks should be suggested based, at least in part, on available ingredient information determined by sensor 229 and/or input received via I/O interface 203. Memory 215 may be configured to store beverage history as part of user profile information.

User profile information may include information uniquely identifying a user of beverage dispenser 200. User profile information may include, but is not limited to, a user name, a photograph, a biometric identification, geographic data including addresses, GPS data, credit card information, bank account information, payment account information, other payment information, digital coupons, a password, a pass code, driver license information, other identification card information, beverage order history, multimedia delivery information, and/or user preferences, such as, for example, beverage preferences. According to some embodiments, user profile information may be stored on server 234, database 235, or another client 233. User profile information may also be stored in a remotely located client beverage dispenser 238. Accordingly, beverage dispenser 200 may communicate with client beverage dispenser 238, which may be operatively connected to dispenser 200 via communication network 236.

According to some embodiments, controller 201 may access a user profile. User profile information may be stored in memory 215, server 234, database 235, client beverage dispenser 238 or in another operatively connected device. User profile information may also be stored on a computer-readable memory, such as, for example, a flash drive, a smart card, and/or an RFID memory, etc. According to some embodiments, processor 202 may communicate with server 234 to retrieve beverage suggestions from the data stored in server 234 based on the same or similar ingredients or characteristics. For example, processor 202 may access user profile information and determine that, on four previous occasions, the user has ordered beverages containing cranberry juice. Processor 202 may determine that cranberry juice is a liquid ingredient currently in reservoir(s) 22. Processor 202 may retrieve beverage recipes from server 234 and/or memory 215 that are cranberry juice based, and present a listing of cranberry juice based beverages for which beverage dispenser 200 is configured to prepare.

According to some embodiments, the beverage suggestion engine may suggest beverages based on other characteristics that have been previously tagged by the user or previously stored by a system administrator. The characteristics may include characteristic preferences based on a taste preference received by processor 202 from a user. For example, a taste preference may include flavor characteristics such as, for example, beverage strength (higher or lower proportions of a liquor ingredient), sweet (higher proportion of a sweet ingredient), sour (higher proportion of a sour ingredient), etc.

According to some embodiments, dispenser 200 may store user profile information on memory 215. Dispenser 200 may be configured to display a list of beverages according to unique beverage preference information stored as part of the user profile information. Processor 202 may direct output device 206 to present the list as a user-selectable list containing beverages with a predetermined taste characteristic preference for which beverage dispenser 200 is configured to prepare. Suggested beverages may be based on data corresponding to liquid and/or solid ingredients contained in reservoir(s) 22, which may be stored in memory 215. Dispenser 200 may interact with one or more operatively connected computer-readable memories to retrieve and display a list of beverages based on this selection and data (hereafter “suggested beverages”).

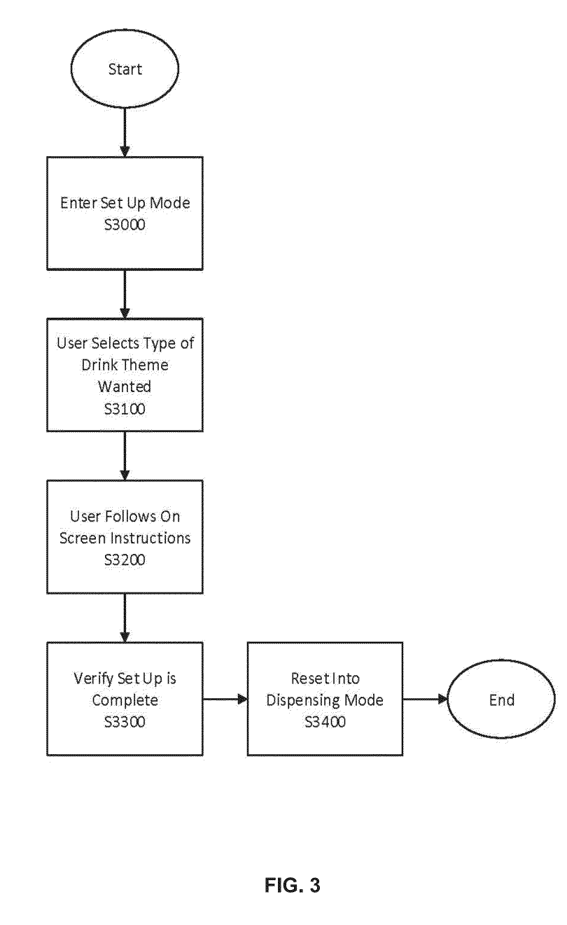

FIGS. 3-6 illustrate methods for performing operations associated with setup of the dispenser, ordering from dispenser 200 and various methods for providing beverage suggestions to a user according to disclosed embodiments. The operations presented below are intended to be illustrative. In some embodiments, the methods may be accomplished with one or more additional operations not described, and/or without one or more of the operations discussed. Additionally, the order in which the operations are illustrated in FIGS. 3-16 and described below is not intended to be limiting.

According to some embodiments, the methods may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium, such as memory 215 shown in FIG. 2. The one or more processing devices may include one or more devices configured through hardware, firmware, and/or software to be specifically designed for execution of one or more of the operations of the methods.

FIG. 3 illustrates a method for the set up and refilling of reservoirs according to exemplary embodiments. Upon receipt of a start command, the process begins at operation S3000. The start command may include user input corresponding to a selection of a control button that initiates a set up mode. The start command may be one of a series of user-selectable administrative functions executable by dispenser 200. At operation S3000, processor 202 may execute instructions to place the dispenser in a set up mode. In the set up mode, processor 202 may disable dispensing components and pumps of the dispenser to prevent beverage preparation during the set up mode. Accordingly, processor 202 may instruct pump mechanisms 23 to remove any ingredients remaining in the hoses connecting the pump mechanisms 23 and nozzle 25, which may be present from a previous operation.

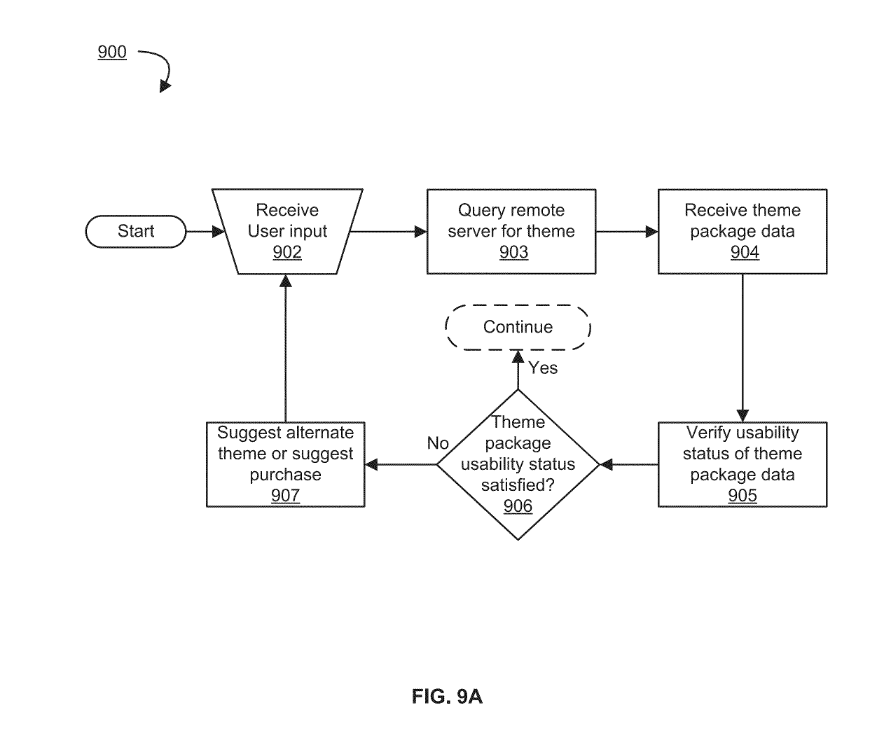

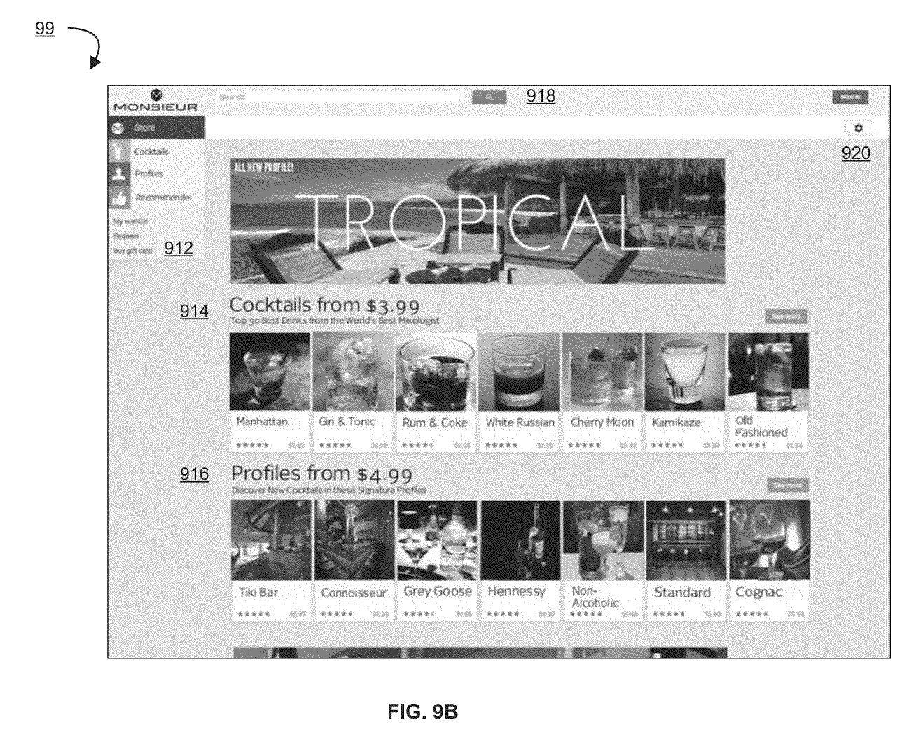

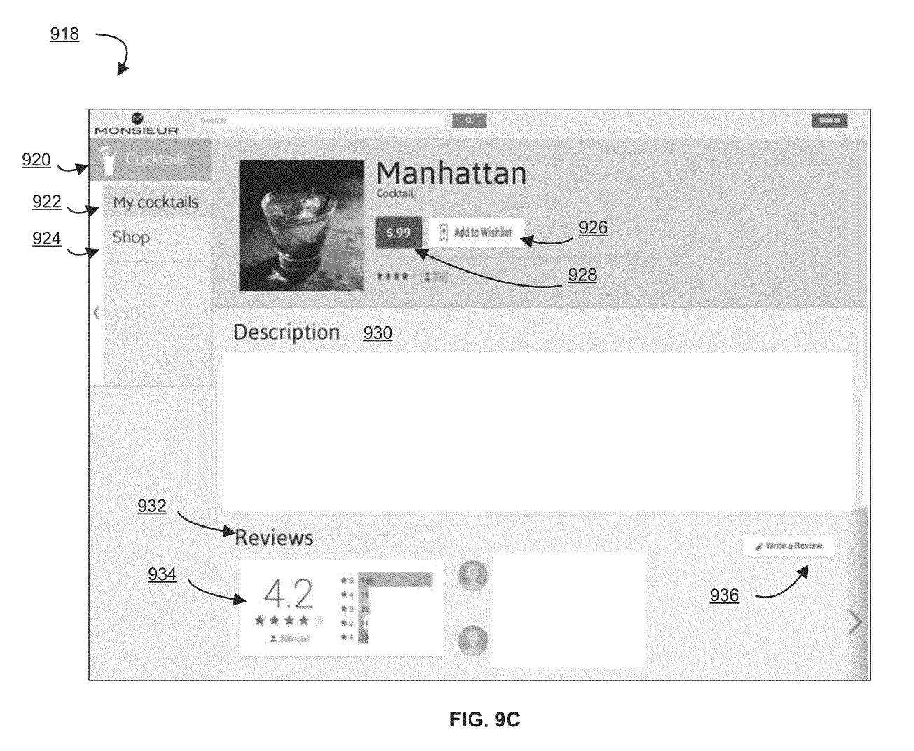

At operation S3100, processor 202 may cause output device 206 to display a message prompting a user to select a beverage from a series of beverage themes stored in memory 215. Input device 205 may receive user input indicating a selection of a beverage theme. Accordingly processor 202 may cause output device 206 to display human-readable instructions for filling the dispenser. Processor 202 may prompt the user, via output device 206, to select a beverage configuration for dispenser 200. For example, processor 202 may select beverage themes according to various beverage themes (discussed in further detail with respect to FIGS. 9A-9C). Examples of beverage themes may be a geographic theme (e.g., Hawaiian, Caribbean, Louisianna/Mardi Gras, etc.,) or be a theme based on beverages made from specific liquid ingredients (such as, for example, vodka based drinks). According to some embodiments, the beverage theme presented to the user may be based on a brand of beverage. For example, the processor may be preprogrammed with beverages based on Bacardi™ brand ingredients.

At operation S3200, processor 202 may cause output device 206 to display a series of instructions to the user for filling each reservoir with a particular ingredient, based on the beverage themes selected by the user at operation S3100. For example, processor 202 may display an instruction via output device 206 instructing the user to fill a particular reservoir with orange juice, and to fill another reservoir with cola. The instructions may also include directions for loading solid ingredients into one or more particular reservoirs.

At S3300, processor 202 may cause output device 206 to display a user prompt for a verification input that the instruction steps have been completed. Once processor 202 determines that input device 205 has received a confirmation that setup steps are complete, at step S3400 the processor may reset dispenser 200 by priming the pumps (e.g., pumps 226, 226, etc.). Processor 202 may execute instructions corresponding to a “dispense mode.” “Dispense mode” may be one mode of a plurality of modes of dispenser 200.

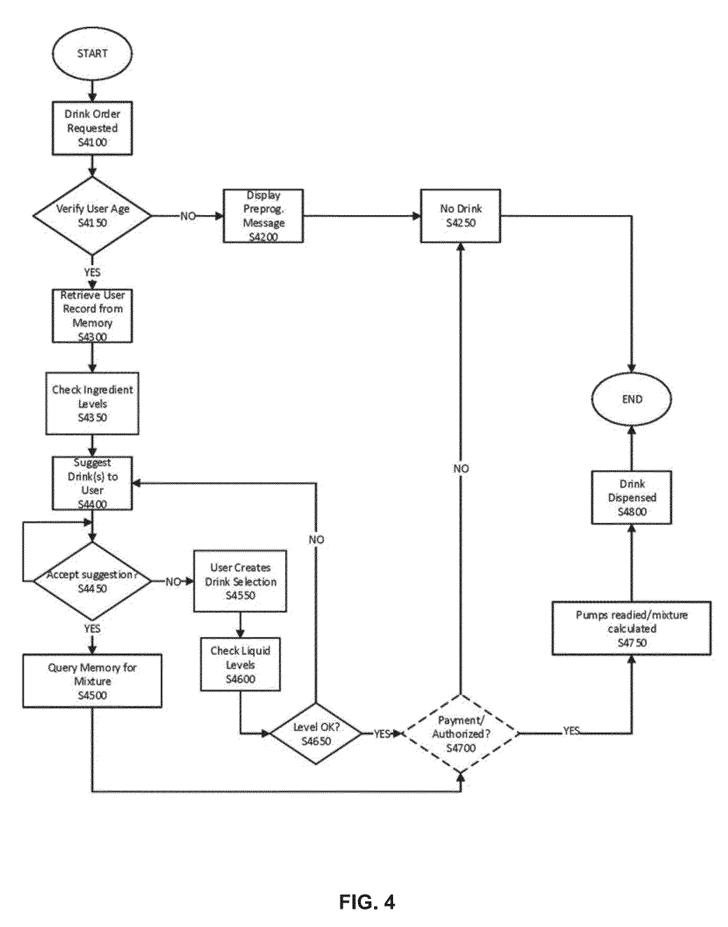

FIG. 4 illustrates a method of providing a beverage suggestion to a user based on a user's age and/or previously stored beverage profile. At operation S4100, controller 201 may receive user input corresponding to a start command. The start command may be initiated by selection of an icon on display 206, which may correspond to an order for a beverage. The process may then move to operation S4150.

At operation S4150, if necessary, the processor may initiate age verification module 223. In some geographic regions, beverages containing substances that may influence behavior (for example, alcohol, herbal extracts, etc.) may be restricted to individuals at or above a pre-determined age. For example, in many jurisdictions, the age required for consumption of alcohol may be 21 years of age.

Age verification module 223 may be configured to ensure that the user is of an age suitable to purchase one or more beverages from dispenser 200. During the setup process of FIG. 3, processor may prompt the user to indicate which reservoir has ingredients containing alcohol. If a subsequent beverage is ordered containing ingredients from one of the reservoirs previously indicated as having alcohol or another controlled substance, controller 201 may request that the user verify their age. Age verification may be performed by input device 206, such as, for example, a camera, a microphone, an RFID device, an identification card scanner, near-field communication (NFC) from a phone, and/or biometric readings of the user. Age verification module 223 may further include verification via face recognition, a pre-configured user login, password, identification code, etc. Further, as discussed in detail above with respect to FIG. 1B, the age verification module 223 may receive inputs from one or more devices coupled to dispenser 10′ and/or from one or more external devices, such as a user's mobile device. If the age of the user is not verified, the process moves to operation S4200, where the controller 201 may prompt a display of a pre-programmed message indicating that the age verification was not complete, and thus, no beverage is dispensed. At step S4250 the process ends.

If the age verification module 223, in conjunction with controller 201, determines that the user's age is verified and suitable for the selected drink, controller 201 may retrieve a user record from memory 215, or other operatively connected computer-readable memory. Accordingly, controller 201 may determine whether the user has a favorite beverage(s) or a beverage that they have previously stored as a beverage that they would like to try. If a previously stored user profile corresponding to that particular user is not accessible or does not exist, the process may proceed to operation S4350, where sensor(s) 229 may read the ingredient levels in the reservoirs 22, and controller 201 may determine the beverages to suggest to the user at operation S4400.

If a user profile is available and retrievable by processor 202, controller 201 may check ingredient levels and determine which ingredients are available for drink preparation. Controller 201 may then retrieve from memory 215 any beverages that can be made from the ingredient levels available in the reservoirs that are the same or similar to beverages stored as user history in the user's profile, and a list of beverages may be displayed by output device 206. If a user profile is unavailable, controller 201 may compute a list of beverages to display as a suggestion to the user, based on the available ingredients in the reservoirs, and further based on beverage recipes previously stored in the dispenser. Additionally, characteristics such as, for example, the strength of beverage, and/or the most ordered beverage or beverages suggested from a user through a mobile device application may be used by controller 201 to determine suggested beverages to display.

At step S4400, controller 201 may cause output device 206 present one or more suggested beverages to the user, and request user input. The process may proceed to operation S4450 where the processor may prompt for the user to select one of the suggested beverages or prompt for user input indicating that the user wishes to make their own selection. Input device 205 may also receive user input indicating that the user wishes to create a beverage selection. Accordingly, input device 205 may receive user input representing a selection from the list of beverage suggestions. At operation S4550, the user may choose to create their own mixed ingredient beverage based on the ingredients already contained in the dispenser. Here, controller 201 may present options for selection of each ingredient to be mixed and dispensed for consumption. Accordingly, controller 201 may output, via output device 206, user-selectable buttons or numbers representing the number of of selections on the display indicating how many units of each ingredient the user wants dispensed. For example, the user may select two units of cola and one unit of rum to be dispensed, provided that the liquid ingredients are available in the reservoirs and the ingredient levels are adequate. Upon completion of the selections, the process may proceed to operations S4600 and S4650, where processor 202 may query sensor 220 to determine whether the selected ingredient units are present in the dispenser. For example, if the two units of cola are not available in the reservoirs, controller 201 may present a message indicating that the selected beverage cannot be dispensed. Therefore the process returns to operation S4400 where the processor may perform operations to suggest beverages to the user based on the ingredient levels available in the dispenser. Alternatively, the process may proceed to step S4700 where a payment for the selected beverage may be requested by controller 201. In one aspect, output device 206 may perform one or more steps of operation S4450. According to other aspects, controller 201 may perform one or more steps associated with operation S4450.

Returning now to operation S4500, controller 201 may query memory 215 for a recipe of the selected beverage. The process may proceed to operation S4700, where a payment may be requested and authorized. According to some embodiments, payment information may not be necessary in order to dispense a drink. Accordingly, if controller 201 determines that a payment is not required, the process may bypass S4700 and proceed to operation S4750. For example, if dispenser 200 is configured for home use, no payment may be required to prepare a beverage.

According to yet other embodiments, payment information may be necessary. For example, dispenser 200 may be operating in a bar or restaurant environment, and thus, may be configured to require payment. If controller 201 determines that payment authorization is necessary at step S4700, controller 201 may determine whether a payment is authorized (data indicating the successful transfer of funds is received by controller 201). If payment is authorized, controller 201 may proceed to step S4750. If payment is not authorized, controller 201 may display an appropriate message via output device 206.

At operation S4750, the pumps may be readied (i.e., primed, etc.), and an approximate volume for a beverage receptacle (i.e., a cup, glass, mug, etc.) may be determined by controller 201. According to some embodiments, pumps 224 connected to the respective reservoirs containing the liquid ingredients needed to prepare the selected beverage may be readied via instructions from controller 201. At step S4750, controller 201 may determine whether a receptacle is present to receive the dispensed beverage, and may further determine the size of the receptacle. Accordingly, controller 201 may recalculate the recipe to fill a larger receptacle, or reduce the recipe to fill a smaller receptacle. For example, controller 201 may initially calculate a recipe for a 10 oz. beverage. Should the user put an 18 oz. receptacle in the recess, controller 201 may recalculate the recipe to dispense an 18 oz. beverage, rather than a 10 oz. beverage. The beverage may then be dispensed at operation S4800.

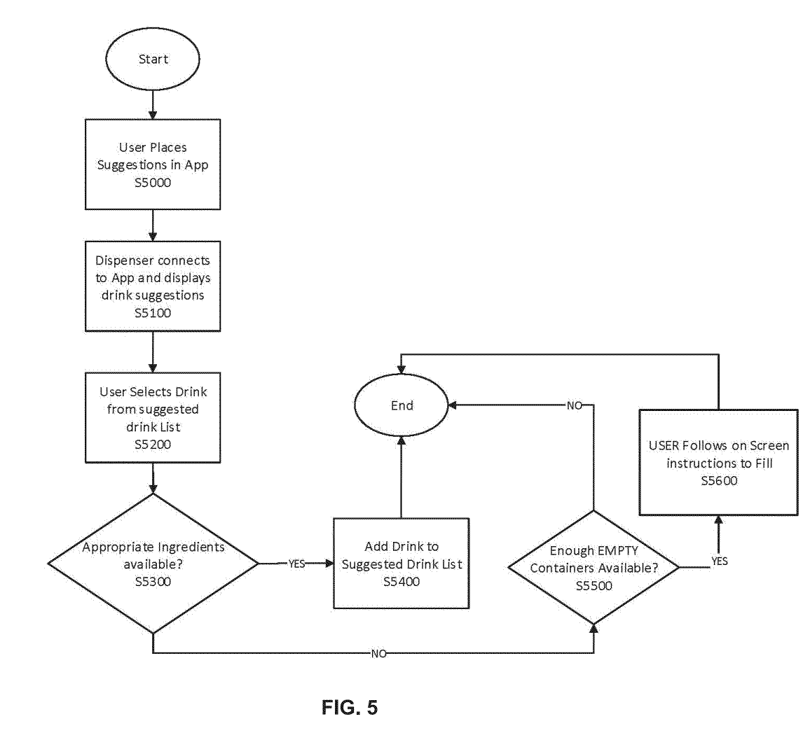

Referring now to FIG. 5, a method of providing a beverage selection via a mobile device is considered. At step S5000, controller 201 may present user-selectable options for identifying a preferred beverage. According to some embodiments, controller 201 may prompt client 237 to present user-selectable options that may identify a preferred beverage associated with a unique user. After controller 201 has received input data indicating a preferred beverage, controller 201 may store the data associated with the input may in memory 215, and/or in a memory of an operatively connected client device 237. Accordingly, the preferred beverage data may be stored for a future recommendation to that unique user.

According to some embodiments, data indicating an identification of the user, drink selection data, profile data, etc. may be synchronized between remote server 234, client 237, and/or database 235.

At operation S5100, dispenser 200 may connect to server 234 to retrieve data that may include suggested beverages associated with the unique user. Accordingly, controller 201 may transmit a request to server 234 to transmit the data indicating the suggested and/or preferred beverages associated with the user. Server 234 may subsequently transmit the data to beverage dispenser 200. The dispenser may then store the data indicating the suggested beverage list in memory 215 for use and display to the user via output device 206.

At operation S5200, client 237 may present a user-selectable suggested beverage list. Accordingly, the user may select a beverage from the suggested beverage list. At operation S5300, processor 202 may query a liquid level reader (i.e., sensor 229) to verify whether the needed ingredients are present in the dispenser and are sufficient in volume to prepare the selected beverage. If the sufficient liquid ingredients are present, the processor moves to operation S5400 where the beverage is added to the suggested beverage list and output to the display. If not, the process may proceed to operation S5500, where controller 201 may determine whether there are enough empty reservoirs available to add the necessary ingredients. If there are enough empty reservoirs, the process may proceed to operation S5600, where screen instructions to fill the reservoirs with the ingredients needed for the suggested beverage may be displayed on output device 206.

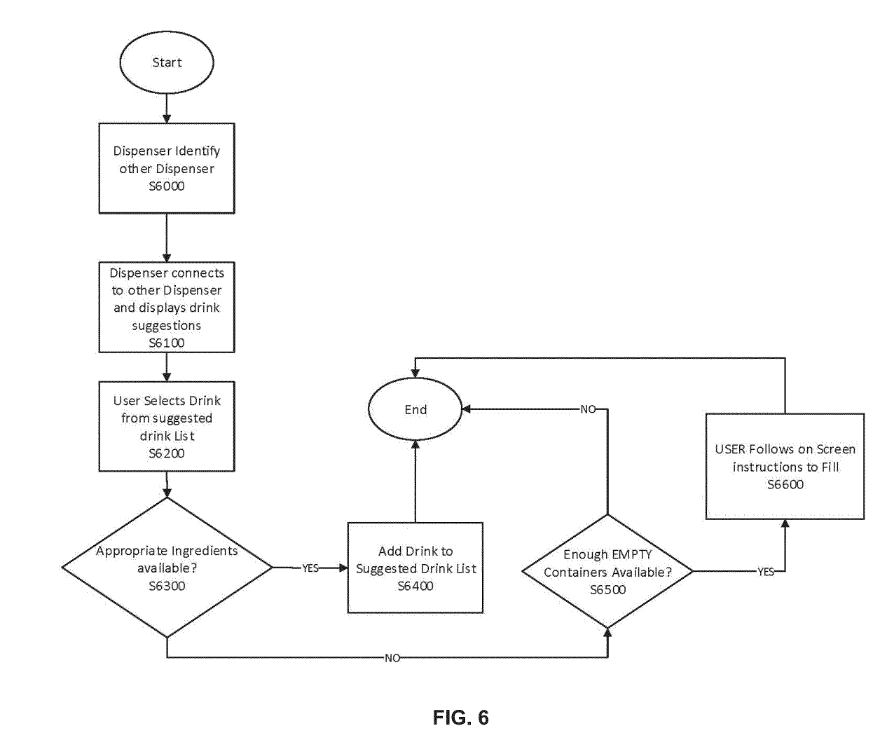

FIG. 6 illustrates the use of data suggested beverages, where the data may be located on a dispenser remotely located from dispenser 200. For example, the requesting dispenser 200 may query remotely located client beverage dispenser 238, and request transmission of data that may include a list of suggested beverages associated with a particular user. At step S6000, dispenser 200 may initiate commands to remotely connect to client beverage dispenser 238 via communication network 236. At operation S6100, beverage dispenser 200 may retrieve data indicating an identified suggested beverage. Accordingly, dispenser 200 may store the suggested beverage data to memory 215, and display the suggested beverage list via output device 206.

At operation S6200, controller 201 may receive user input via input device 205 in connection with a user selection of a beverage from the suggested beverage list. From there, the process moves to S6300, where the controller 201 may query a liquid level reader (i.e., sensor 229) to determine whether that the needed ingredients are present in the dispenser 200. If controller 201 determines that the necessary ingredients are present, at operation S640 controller 201 may display to the suggested beverage list via output device 206. If needed ingredients are not present, the process moves to operation S6500 to determine whether there are enough empty reservoirs available to add the necessary ingredients to prepare the selected beverage. The process may proceed to operation S6600 where controller 201 may output instructions via output device 206 to fill the reservoirs with the ingredients needed for the suggested beverage.

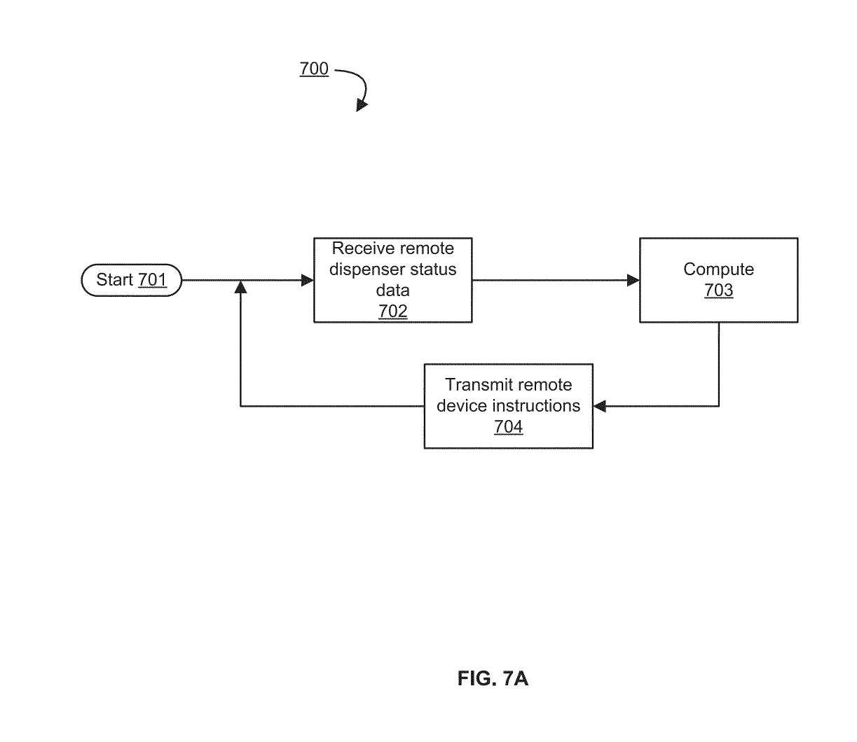

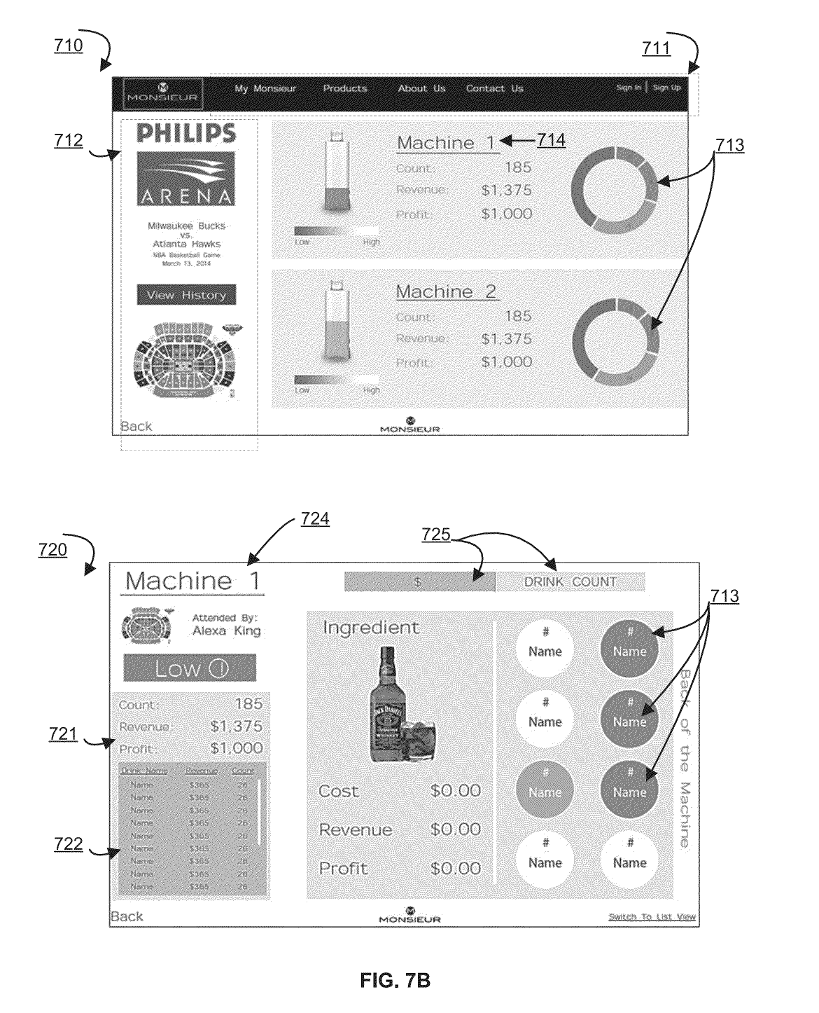

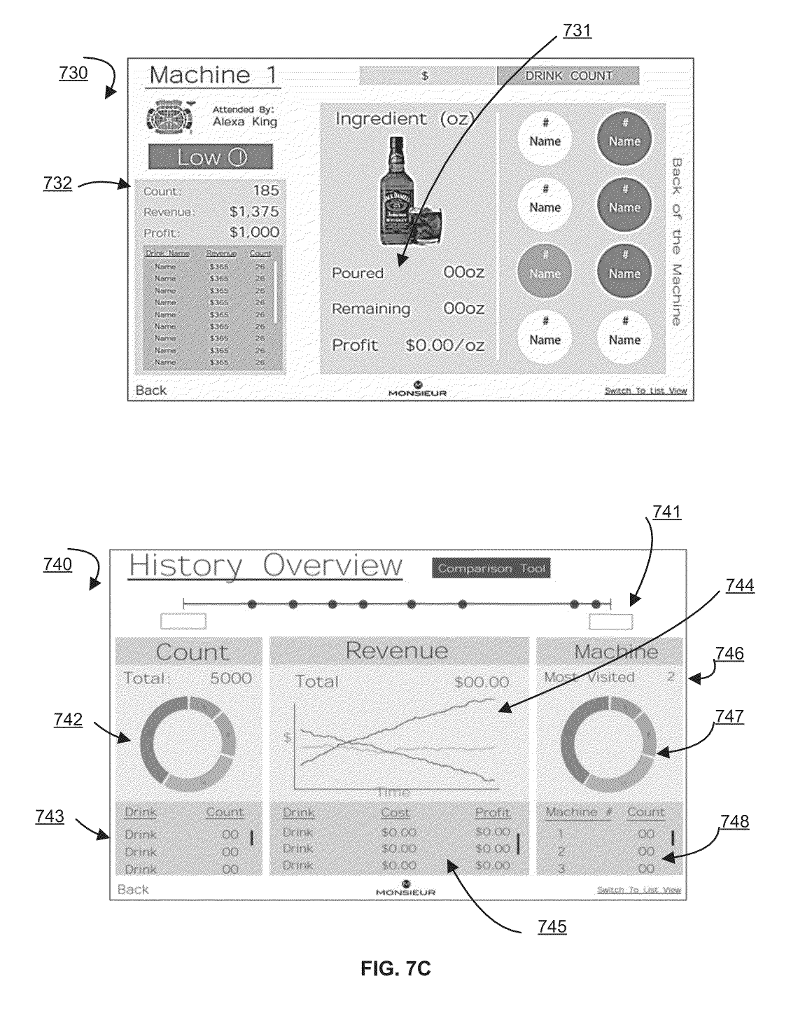

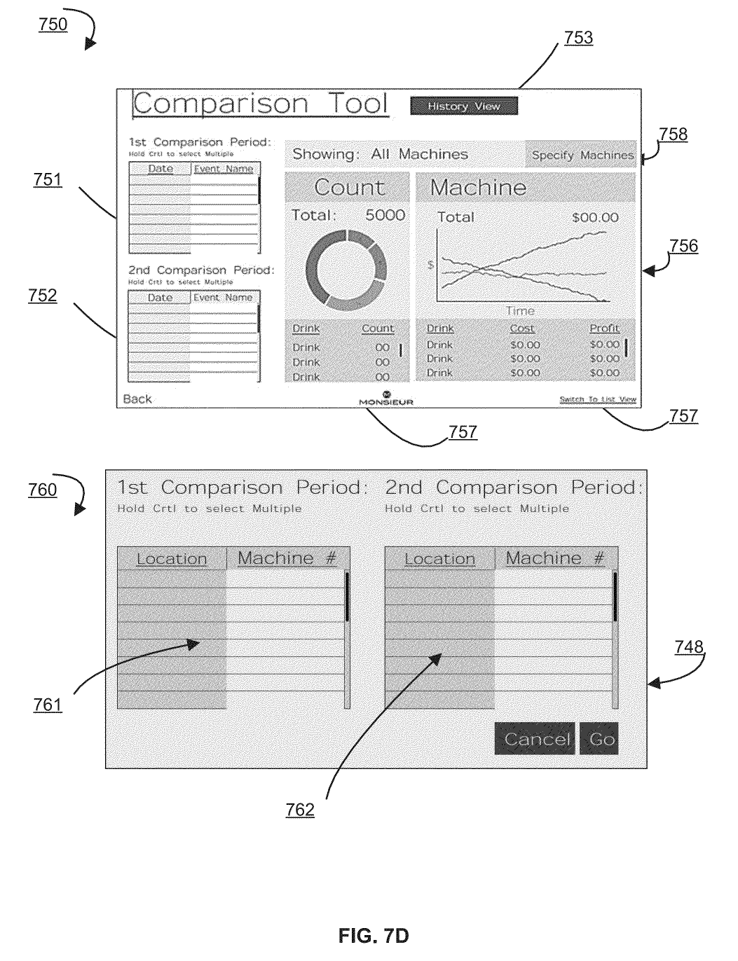

FIG. 7A depicts an exemplary process for providing central management of a plurality of beverage dispensers. According to some embodiments, a process for central beverage dispenser management (hereafter “process 700”) may be provided by a system (hereafter “central management system 700”) for monitoring, controlling, and/or operating a plurality of beverage dispensers and/or operatively connected devices, such as client 235, client 237, and/or client beverage dispenser 238. Central management system 700 may be further configured to transmit (upload, etc.) new beverage selections for inclusion in the suggested beverage listings of connected devices of system 700, submit updates and new versions to the mobile application used by client device 237, to transmit multimedia data to any one or more connected device of system 700, and to modify pricing, business rules, and other information in connection with providing beverages. Central management system 700 may include an operatively connected computing device configured for controlling multiple dispensers, for example, client 233. According to some embodiments, system 700 may also provide central control via mobile device 237, or via a server 234, which may be in communication with client beverage dispenser 238 and beverage dispenser 200 through communication network 236.

According to some embodiments, server 234 and database 235 may receive data indicating dispenser status, and transmit the dispenser status data to one or more other connected beverage dispensers (for example, 200 and 238), and/or provide the machine status data to the controlling device client 233. Dispenser status may include, but is not limited to information uniquely identifying a beverage dispenser, dispenser power status, and dispenser hardware status (e.g., operability information including nozzle 227, stir mechanism 228, sensor 229, solid ingredient dispenser 230, beverage shaker 231, ice dispenser 232, pump bank 224, and controller 201). Dispenser status may further include ingredient levels, historic beverage preparation data, time information, interface interaction information, information indicating unique user application data, user profile data, etc.

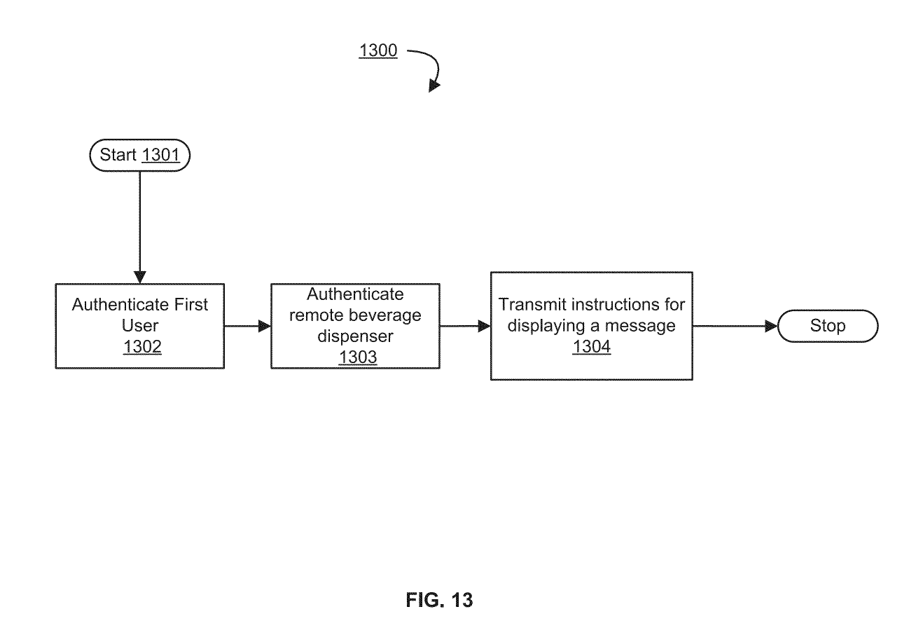

Dispenser status may also include metadata indicating user interaction information, where the interaction information may be derived from user interaction with input device 205. According to some embodiments, a multimedia file containing product information may be transmitted from client 233 to beverage dispenser 200 (discussed in more detail with respect to FIG. 13). Accordingly, a user may interact with input device 205, and controller 201 may generate metadata corresponding to the interaction. As another example, if controller 201 presents multimedia information containing product information that includes certain qualities of beverage X, and the user actuates user-selectable buttons indicating, for example, interest in learning more about beverage X, or the user orders beverage X as a result of the interaction, controller 201 may store the metadata associated with the user interaction may in memory 215 as part of user application data 221, or as part of another module.

In general, process 700 may include an iterative process that may include a receive remote dispenser status step 702, a computation step 703, and a transmit step 704. According to some embodiments, central management process commences at step 701 by executing the central management process 700 from the controlling device client 233. Client 233 may receive a dispenser data update (step 702) containing dispenser status of one or more of a plurality of remotely located dispensers that have been configured for control by client 233. The plurality of remotely located dispensers may be geographically located in the same establishment, or may be located in a different location (in another establishment, in a different city, etc.).

At step 703, client 233 may compute the dispenser status update. Computing the dispenser status update may include processing one or more dispenser statuses received from the remotely located dispensers. According to some embodiments, client 233 may organize the processed dispenser statuses into a graphical user interface (GUI). FIGS. 7B-7D illustrate an exemplary user interface according to some embodiments.

Referring to FIG. 7B, a user interface 710 illustrates an exemplary a global view screen. Interface 710 may include a graphical display area 712, configured to display information associated with the dispensers managed by management system 700. All information provided by interfaces 710-760 may be computed by client 233, based at least in part, on information received as part of a dispenser status update. For example, display area 712 may include graphics, and/or links that may provide information in connection with the physical location of each dispenser managed by client 233. According to one embodiment, a plurality of dispensers may be located in a sports arena. A map may be provided showing the location of each dispenser 712.

Interface 710 may provide user-selectable control buttons 711 for providing links for profile information, product information in connection with the specific products offered by the plurality of managed dispensers, company information, a link for an email client, etc. Interface 710 may provide financial information 713 in connection with each machine under management system 700. For example, financial information may include a count of drinks sold at each dispenser, total revenue earned by the dispenser, and an estimated profit. Interface 720 may provide a selectable control button 714 that may link to an interface providing additional information in connection with a particular one of the plurality of dispensers managed by central management system 700.

Interface 720 illustrates an exemplary interface providing additional information in connection with a remotely-located beverage dispenser. For example, interface 720 illustrates an interface according to some embodiments that may provide historic beverage preparation data, and/or financial data associated with the particular dispenser. According to some embodiments, interface 720 may show revenue earned with respect to a plurality of types of drinks offered by the dispenser 722. Interface 720 may also provide information associated with beverage ingredient levels 723, and may further provide an alert for any ingredient levels that are low or empty 724. Interface 720 may further include user-selectable control buttons that provide access to drink count information, and financial information 725.

FIG. 7C illustrates an exemplary interface for showing drink count information 730 with respect to a particular remotely-located beverage dispenser. Interface 730 may show information showing served beverage volumes 731, financial information and/or beverage ingredient level information 733.

FIG. 7C also depicts an exemplary overview comparison tool 740 (hereafter “comparison tool”), according to embodiments of the present disclosure. Comparison tool 740 may be configured to provide a historic overview of various dispensers under the management of system 700. For example, according to some embodiments, comparison tool 740 may provide time information that may include graphical and/or numeric information containing time information, where the time information may be a timeline showing the times at which one or more beverages were purchased from a dispenser of system 700 (element 741). The time information may be pre-determined periods of time. A pre-determined time period may be, for example, a user-selected period of time in minutes, in hours, days, months, etc. Although not shown, comparison tool 740 may include user-selectable control buttons that may provide means for receiving user selection of applicable time periods for comparison.

Comparison tool 740 may further include a graphic representation of beverage count information 742, where beverage count information may include a count of beverage sales with respect to all dispensers of system 700. Drink count information may further include drink count information as a numerical representation 743. Comparison tool 740 may further include a graphical representation of total revenue with respect to individual beverages 744, and/or a numerical representation of beverages cost and profit information 745.

According to some embodiments, comparison tool 740 may also include beverage sale information showing the most visited dispenser 746 (e.g., the dispenser that has prepared and/or sold the most beverages with respect to a pre-determined time period), a graphical representation of the drinks served on the machine most visited 747, and/or a numeric representation of beverage count information with respect to a particular group of machines under management of system 700 (element 748), and with respect to a pre-determined time period.

FIG. 7D depicts an exemplary user interface 750 that may be configured to work with comparison tool 740. Interface 750 may provide information related to one or more of a plurality of dispensers managed by system 700, where the information may be organized according to particular events (e.g., a sporting event, wedding, social gathering, etc.), and/or organized by particular pre-determined periods of time. For example, interface 750 may provide graphic and/or numeric information organized by date and/or event name 750, where a first date and/or event can be compared with a second date and/or event 752. The first element for comparison may include a group of dates and/or events. Accordingly, the second group for comparison with the first group may also include a plurality of dates and/or events.

According to some embodiments, comparison tool 740 may provide information with respect to a total count of all beverages served within the selected dates and/or times 753. The total count information may include a graphical representation of the total beverages served 754, and/or a numeric representation of the beverages served 755. According to yet other embodiments, comparison tool 740 may provide machine-level information 756, where the machine-level information may be configured to provide beverage type, cost per beverage and respective profit per beverage 757. Accordingly, comparison tool 740 may include user-selectable control buttons 758 that may be configured to select the respective dispensers to be included in the machine-level comparison.

Interface 760 depicts an exemplary interface that may be configured to provide information as part of comparison tool 740. Comparison tool 740 may be configured to receive input where the user may select a first group of events to be compared, and a second group of events to be compared. According to some embodiments, only a single date/even may be selectable, or a pre-determined number of dates/events may be selectable for comparison.

Referring again to FIG. 7A, computing step 703 may provide computing tools such as, for example, comparison tool 740, and may provide a various user interfaces as depicted above in FIGS. 7B-7D. According to some embodiments, client 233 may be configured to issue device instructions 704. Device instructions may include, but are not limited to, instructions to execute a multimedia file, a device firmware update, a software update, a power-up or power-down command, and/or instructions limiting the types of beverages that may be offered by the remote dispenser. For example, client 233 may transmit instructions to remote dispenser 200 to power up, update firmware, and serve any beverage for which dispenser 200 has liquid and/or solid ingredients available until 3:00 AM. The instructions may include instructions to serve only soft drinks (i.e., non-alcoholic beverages) from 2:00 AM to 3:00 AM and to power down at 3:00 AM.

According to some embodiments, remote device instructions may include instructions to output an alert or a message. For example, the instructions may include instructions to play a “last call” alert via output device 206. According to yet other embodiments, the instructions may include instructions to play a multimedia file, such as a video or advertisement. Remote device instructions may further include information on beverage pricing information.

According to some embodiments, remote device instructions may include instructions to prevent the sale and/or dispensing of a beverage to a particular user. For example, if dispenser management system 700 determines that a particular user has a negative history with the establishment (i.e., over consumption of alcoholic beverages, disorderly conduct, purchasing beverages for a minor, etc.) system 700 may temporarily or permanently bar that user from using that particular dispenser, or any number of dispensers of system 700.

According to yet other embodiments, remote device instructions may include instructions to limit the number of beverages of particular types that may be served to a unique user. For example, system 700 may direct dispenser 200 to provide a maximum of two beverages. According to other embodiments, the instructions may include instructions to provide a maximum of a pre-determined number of beverages during a pre-determined time period. Accordingly, if the particular user attempts to exceed the set limit, system 700 may output an appropriate message.

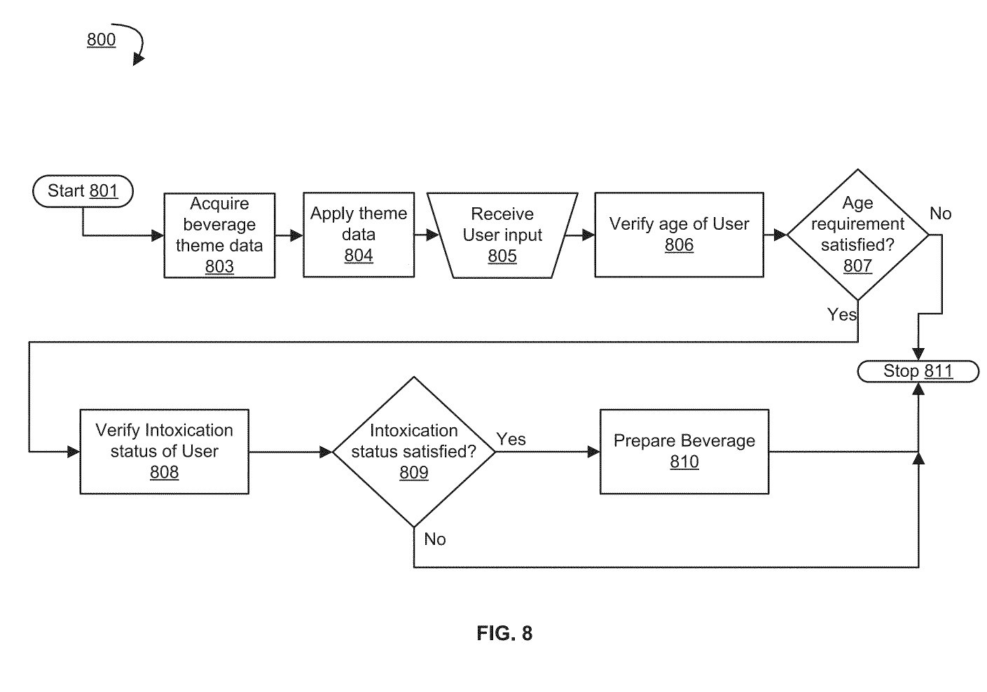

Referring now to FIG. 8, a flow diagram illustrating a method for beverage preparation is provided in accordance with some embodiments of the present disclosure. At step 803, controller 201 may acquire beverage theme data. Beverage theme data may be stored locally in memory 215, and/or be stored in an operatively connected device such as client 233 or server 234. Beverage dispenser 200 may apply theme data 804, and receive user input indicating the beverage selection 805.

FIG. 9A depicts an exemplary process for acquiring beverage theme data according to disclosed embodiments. At step 902, controller 201 may prompt for input via output device 206, where the input may indicate the selection of a particular beverage theme in accordance with disclosed embodiments. Input 205 may receive input regarding the selection of a particular theme package. Controller 201 may query a remote server 234 to request transmission of the theme package. Accordingly, server 234 may transmit the theme package to beverage dispenser 200 (step 904), and dispenser 200 may save the data to memory 215.

At step 905 controller 201 may determine a usability status. According to some embodiments, a usability status may include the status of whether the theme package requirements have been satisfied. Theme package requirements may include, but are not limited to, a required fee for download of the package, whether model of beverage dispenser can support the downloaded theme package, whether update dispenser software and/or firmware, etc. has been sufficiently updated, etc.

For example, server 234 may offer some theme packages as a complementary package (no financial compensation is required). Accordingly, the requirement for financial compensation has been satisfied. According to yet other embodiments, a package requirement includes a requirement for payment for the theme package.

FIG. 9B depicts an exemplary user interface for beverage theme data acquisition. The system of FIG. 9A may provide a user-selectable navigation tool 912 that may provide links to a “Store” where beverage theme packages may be purchased and/or downloaded. According to one exemplary embodiment, the system of FIG. 9A may provide for electronic commerce operations in connection with the sale of one or more ingredients, and/or machine accessories, such as, for example, bottles, cleaning solutions, glassware, and/or other materials. The navigation tool 912 may further include a “Cocktails” link, providing access to a user interface associated with providing information on individual beverages. Navigation tool 912 may also provide links for “Profiles” and “Recommend” links, where an individual user profile may be created and/or edited, and an individual beverage recommendation may be made, respectively. Other links may be provided as part of the navigation tool 912. The system of FIG. 9A may include a search area 918, and a settings tool 920, where user interface settings may be edited and/or set. According to some embodiments, the system of FIG. 9A may provide user-selectable beverage theme packages 914, 916.

FIG. 9B further depicts user-selectable navigation tools 920, 922, and 924, which may be configured to allow a user to navigate between various interface pages. Interface 9B may be configured to include an individual beverage recipe price 928, and a “wish list” tool 926, which may provide means for a user to store a preferred drink of interest to their profile for purchase and/or download at a later time. System 9A may include a description 930, which may be configured to provide auxiliary information regarding the particular beverage of interest. The system of FIG. 9A may include a tool for reviews 932, and may display an average user review 934 for a particular beverage theme and/or beverage. A link may be provided for a user to write a unique review 936.

Referring again to FIG. 9A, at step 906, controller 201 may determine whether the theme package usability status has been satisfied. If the theme package status has not been satisfied, controller 201 may output a suggestion for the use of an alternate theme package. According to some embodiments, controller 201 may provide an interface for purchasing the theme package. Accordingly, controller 201 may prompt a user for payment information. If theme package usability status is satisfied, the beverage preparation process may continue as shown in FIG. 8.

Referring again to FIG. 8, after beverage theme data is acquired 803, controller 201 may apply the theme data 804 by processing the theme data and outputting the appropriate selection menu on output device 206. At step 805 controller 201 may receive input via input device 205 where the data corresponding to the input may indicate a beverage selection.

According to some embodiments, controller 201 may provide user-selectable options for controlling various aspects of the selected beverage. For example, if a data from an input indicating selection of “whiskey sour” is received by controller 201, controller 201 may provide user-selectable options to control the strength of the beverage (for example, the relative proportions of the alcohol-containing components of the beverage to non-alcohol-containing components of the beverage). Controller 201 may further provide user-selectable options for selecting taste characteristics of the selected beverage. For example, controller 201 may present a user-selectable option to determine the level of “sour.” Controller 201 may be configured to provide user-selectable characteristics such as, for example, the sweetness level, whether ice is included, whether the ice is cubed or crushed, whether the beverage is well-shaken or lightly shaken, whether the beverage includes a garnishment (such as, for example, an pickled olive), and/or a type of garnishment desired (for example, a pickled onion, a wedge of citrus, a celery stick, etc.). Controller 201 may present other options in addition to those listed herein, where the options are in connection with the preparation of a beverage.

Controller 201 may be configured to present a user-selectable characteristic input tool where the selection input may be presented as a virtual slider, and is configured to allow the the user to slide the control button to indicate the degree of characteristic desired. More particularly, controller 201 may be configured to receive input indicating a user selection, where the user selection corresponds to a sliding action of a virtual control. For example, the selection input tool may be configured to slide from left (representing a relatively small amount of the characteristic) to the right (representing a relatively large amount of the characteristic). Controller 201 may also receive input via another control (not necessarily shown), either virtual or analog. For example, dispenser 200 may include an input device 205 that includes a dial, a button, a key pad, etc.

After receiving user input indicating drink selection, controller 201 may be configured to verify an age of the user 806 according to disclosed embodiments. If the age requirements are satisfied 807, controller 201 may verify an intoxication status of the user 808. If an age requirements has not been satisfied, controller 201 may stop the beverage preparation process 811.

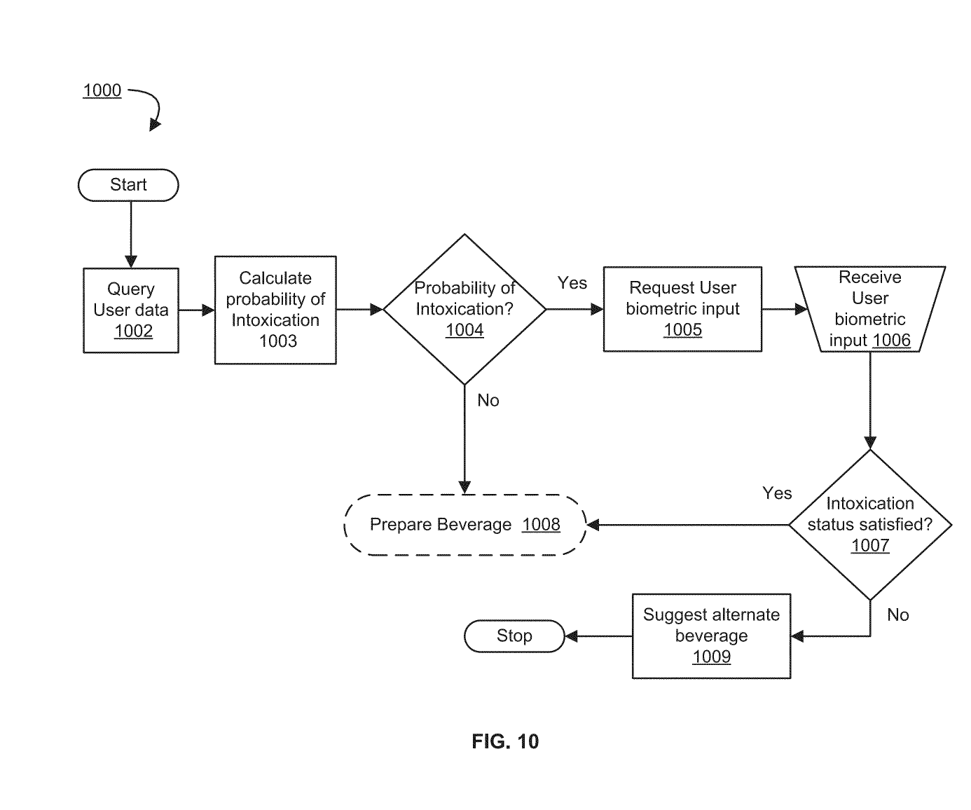

At step 808, controller 201 may execute an intoxication gateway module 222 to verify an intoxication status of the user. FIG. 10 illustrates a method for verifying an intoxication status, in accordance with some embodiments of the present disclosure.

Referring now to FIG. 10, controller 201 may query memory 215 for user application data 221 to determine a probability of whether the user is intoxicated 1002. User application data (hereafter “user data”) may contain information from which processor 202 may calculate a probability of intoxication, such as, for example, the number of alcoholic beverages ordered within a pre-determined time period, the types of beverages ordered, and/or the estimated volume of alcohol included in the consumed beverages, physical characteristics of the user including age, weight, height, etc., and/or historic order information such as, for example, how many drinks within a given time period this particular user has ordered in the past.

According to some embodiments, controller 201 may be configured to determine an estimated blood alcohol level and compare the estimated blood alcohol level to a set of pre-determined intoxication rules. The intoxication rules may be a pre-configured database of relative blood alcohol levels associated with safely accomplishing various activities including, for example, safely walking, driving, etc. Controller may access information related to blood alcohol content rules related to motor vehicle safety with respect to individual geographic locations. For example, the state of Georgia may have blood alcohol content rules distinct from those in Florida.

According to some embodiments, controller 201 may be configured to request a biometric input to determine a blood alcohol level 1005. Biometric inputs may include, but are not limited to, eye tracking, breath analyzer, saliva test, etc. At step 1006, controller 201 may receive the biometric input via input device 205, and determine a probability of intoxication according to the pre-determined intoxication rules. If the intoxication rules are satisfied, beverage dispenser may prepare a beverage 1008. If the rules are not satisfied, the user has a status of “intoxicated.” According to some embodiments, controller 201 may output a suggestion for an alternate beverage 1009, and/or display an appropriate message, such as, for example, the length of time the user should wait before ordering a beverage containing alcohol. Referring again to FIG. 8, if controller 201 determines that the intoxication status is satisfied 809, beverage preparation may commence.

According to some embodiments of the present disclosure, beverage dispenser 200 may be configured to prepare layered beverages (e.g., a pousse-café, slippery nipple, etc.). Layered beverages are beverages where the slightly different densities of various liqueurs are assembled to create an array of unmixed, distinct colored layers, typically three to seven. Generally, in layered drinks known in the art, the specific gravity of the liquid ingredients may be configured to increase from top of the receptacle to the bottom of the receptacle. As a general example, when making a layered beverage, the liquid ingredients with the most dissolved sugar and the least alcohol may be the densest and are poured so as to be at the bottom of the receptacle. Dense liquid ingredients may include, for example, fruit juices and cream liqueurs. Liquid ingredients with the least water and the most alcohol, such as rum with 75% alcohol by volume, are typically “floated” on top of the receptacle. In order to keep the layers separate and unmixed, the individual liquid ingredients are generally be poured very gently to avoid mixing. Accordingly, beverage dispenser 200 may be configured to dispense individual liquid ingredients in such a manner as to avoid mixing, where the individual liquid ingredients are “layered.”

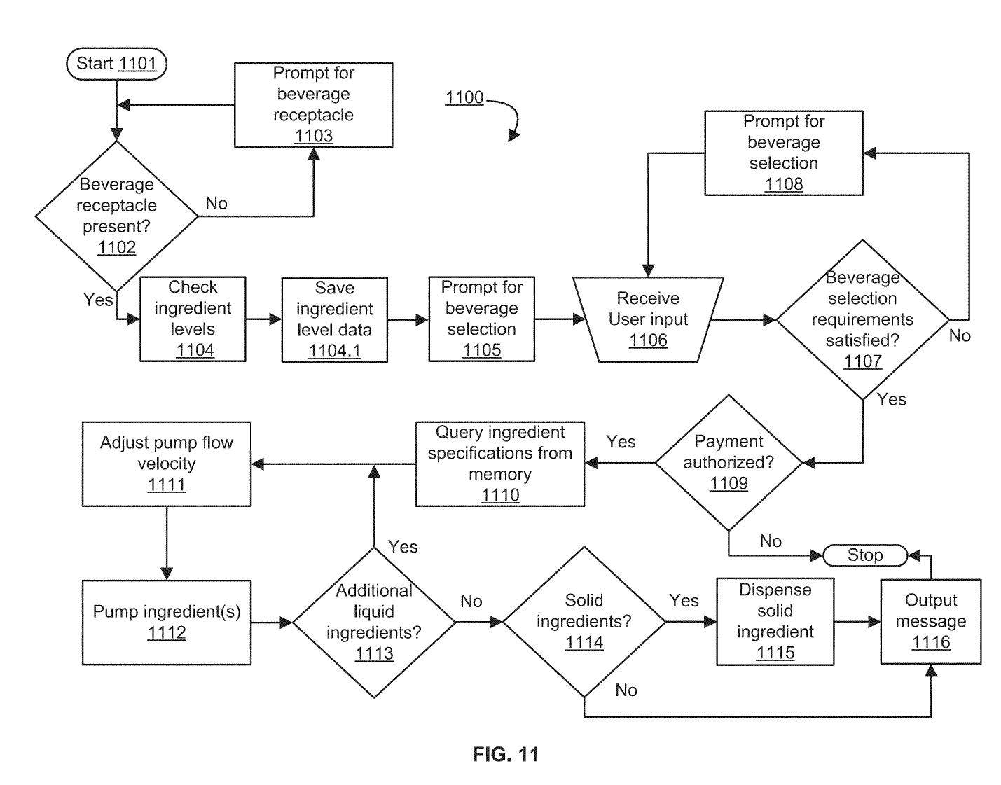

Referring now to FIG. 11, a method of automatic beverage layering is illustrated, in accordance with some embodiments of the present disclosure. At step 1102, controller 201 may determine whether a beverage receptacle is present. If a beverage receptacle is not present, controller 201 may output a request to provide a suitable receptacle 1103. Once controller 201 determines that an appropriate receptacle is present, controller 201 may check the levels of the liquid and solid ingredients 1104, and store ingredient level data on memory 215 (step 1105). Controller 201 may prompt for user input for a beverage selection, and may receive input indicating the same, in accordance with presently disclosed embodiments 1106. At step 1107, controller 201 may determine whether the requirements for the beverage selection are satisfied 1107. Examples of beverage selection requirements may include whether there are levels of liquid and/or solid ingredients sufficient to prepare the selected beverage. If controller 201 determines that the requirements are not satisfied, processor 201 may configure a list of beverages that may be made with the available liquid and solid ingredients. Accordingly, controller 201 may present a user-selectable list via output device 206, and prompt for user input regarding a beverage selection 1108. Controller 201 may receive data from input device 205 corresponding to the user input 1106, and check again to determine whether the beverage selection requirements are satisfied 1107.

Once controller 201 determines that beverage requirements are satisfied, controller 201 may determine whether payment has been authorized 1109. If controller 201 determines that payment is not authorized, process 1100 stops, and no beverage is prepared. If controller 201 determines that payment is authorized, controller 201 may query ingredient specifications from memory 215.

Ingredient specifications may include, but are not limited to, specific densities of liquid ingredients presently loaded in reservoirs 22, an order of beverage layers required to make a corresponding beverage, a pump velocity sufficient to transfer each required liquid ingredient so as to accomplish a “layered” effect, and/or a viscosity of a corresponding liquid ingredient.

Controller 201 may adjust the flow velocity of a corresponding one or more pumps in pump bank 224, where each pump is controlled to pump the corresponding liquid ingredient such that a “layered” effect may be accomplished. Controller 201 may use ingredient specifications to compute the required flow velocities for each respective pump.

For example, pump bank 224 may include pump 225, configured to transfer ingredient A from the connected reservoir, and pump 226 configured to transfer ingredient B from the respective connected reservoir. Controller 201 may determine, after querying ingredient specifications stored in memory 215, that ingredient B should be transferred first at velocity X, and ingredient A should be transferred second at velocity Y, which may be ⅓ the velocity X. Accordingly, controller 201 may adjust each respective pump flow velocity, and pump ingredient B at the appropriate flow velocity 1112. Controller 201 may determine whether another ingredient is needed to complete the selected beverage 1113. If controller 201 determines that another liquid ingredient remains to be transferred to the receptacle, controller 201 may adjust the pump flow velocity accordingly 1111, and pump the remaining liquid ingredient 1112. Each respective ingredient needed to prepare the selected beverage may be pumped at the respective velocity until a layered effect is created, and all liquid ingredients are transferred. When there are no additional ingredients to transfer 1113, controller 201 determines whether a solid ingredient is required in accordance with the selected beverage 1114. If controller 201 determines that a solid ingredient is required, controller 201 may dispense the appropriate solid ingredient 1115 and output a message indicating that the beverage is prepared 1116. For example, at step 1116, controller 201 may output an auditory message, such as, for example, “Your drink is served, monsieur” 1112. Other types of messages are contemplated. If controller 201 determines that no solid ingredient is necessary 1114, then controller may output a message directly 1116. Accordingly, process 1100 is complete.

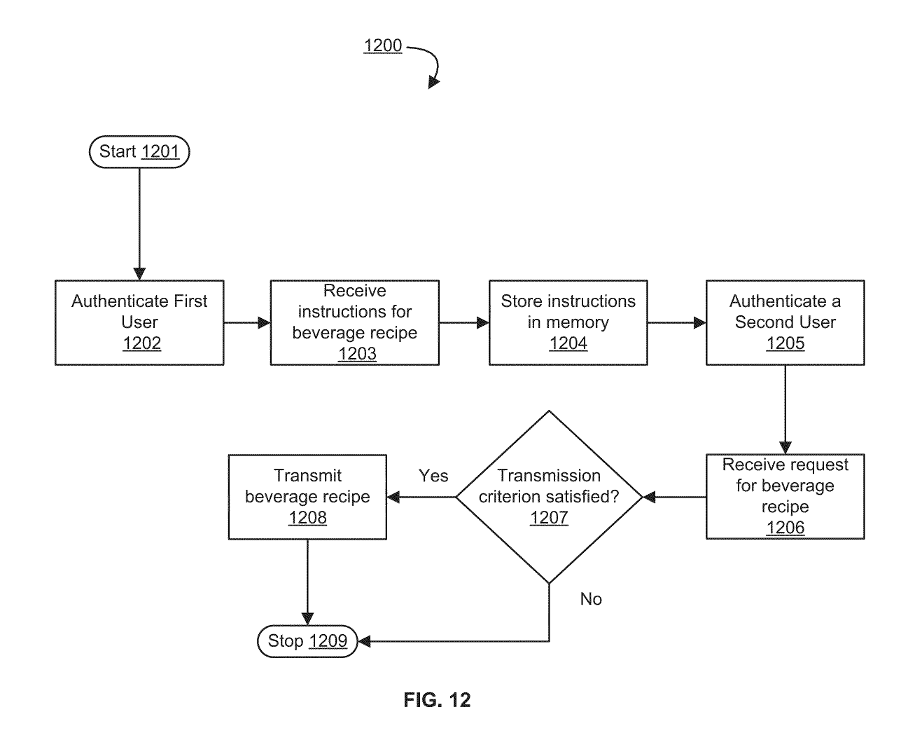

FIG. 12 depicts a method for sharing beverage dispenser recipes in accordance with some embodiments of the present disclosure. Users of automatic beverage dispensers may desire to share beverage recipes online for other dispenser users to download. Accordingly, an online platform for sharing beverage dispenser recipes may be provided in accordance with some embodiments. At step 1202, server 234 may authenticate a first user using unique identification credentials. A first user may upload data that includes instructions for preparing a beverage using beverage dispenser 200 (or a similarly configured beverage dispenser, such as, for example, client beverage dispenser 238). Accordingly, server 234 may receive the data that includes instructions 1203, and store the instructions to memory (e.g., as part of database 235 stored in a non-transitory computer-readable memory). Server 234 may subsequently authenticate a second user 1205, and receive a request transmitted from an operatively connected user device (e.g., client beverage dispenser 238) to transmit data that includes the beverage recipe from the first user 1206. Server 234 may determine whether one or more transmission criteria are satisfied 1207, and transmit the requested data 1208 if the transmission criteria are satisfied. If the transmission criteria are not satisfied, process 1200 may stop 1209.

Transmission criteria may be any one or more of a plurality of criterion. For example, transmission criteria may include whether payment for the requested data is required, whether the requesting device is configured to use the requested data, whether payment is authorized, etc. For example, server 234 may provide one or more user interfaces as shown in FIGS. 9B and 9C, where the second user may browse a variety of beverage themes and individual beverages. Referring again to FIG. 9B, server may receive data indicating a request to transmit beverage theme 914. Transmission criteria may be satisfied if the required fee of $3.99 is satisfied by a transfer of funds from an appropriate payment account (not shown). Accordingly, if the transmission criteria are satisfied, server 234 may transfer the requested data.

FIG. 13 depicts a method for delivering multimedia content in accordance with some embodiments of the present disclosure. It may be advantageous for a user of one or more beverage dispenser to display a multimedia file on one or more dispensers under management, for example, as part of central management system 700. For example, if a user owns and/or operates a plurality of beverage dispensers, the user may desire to play a video or photo slide show on one or more of the dispensers. Consequently, each controller of the dispensers may receive the multimedia file(s), and display the multimedia content on each respective output device of the dispensers. According to some embodiments, the multimedia content may also be sent to one or more mobile devices. The multimedia content may be, for example, a video advertisement, business information, a text message, music, an auditory message, a photograph, etc. The central beverage dispenser management system 700 described with respect to FIG. 7 may be configured to transmit and control multimedia content on one or more remotely connected beverage dispensers.

Referring to FIG. 13, central beverage dispenser management system 700 may authenticate a first user 1302. Authentication may proceed as known in the art using unique user credentials, a password, etc. Accordingly, system 700 may authenticate a remotely located beverage dispenser 1303. The processor of the managing device, e.g., client 233, may issue instructions to transmit data to one or more beverage dispensers under management (e.g., dispenser 200 and client beverage dispenser 238) (step 1304), where the data may include one or more multimedia files. Accordingly, the beverage dispensers 200 and 238 may receive the multimedia information, and save the information to each respective memory. The information may include instructions for executing the multimedia information including, but not limited to rules controlling the multimedia file execution times, and/or the like.

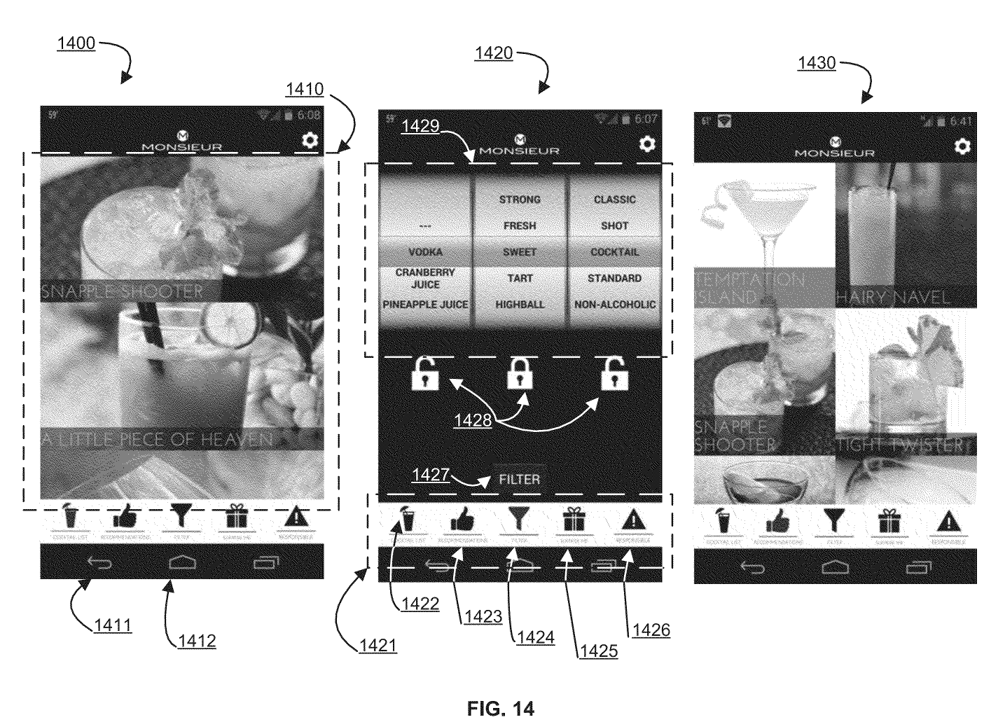

Referring now to FIG. 14, an exemplary user interface for ordering a beverage on a mobile device is shown according to some embodiments. Beverage dispenser 200 may be configured to receive commands from an operatively connected mobile device, such as for example, client device 237. Client device 237 may communicate with the dispenser 200 via communication network 236 or via routing through server 234 to dispenser 200. The server 234 may be in communication with one or more databases 235, that store beverage selections and various items of data (application data) related to providing suggested beverages or beverage recipes to users of client device 237, as well as storing and using user profile data as described herein.

Management system 700 as described with respect to FIG. 7 may be configured to send and receive data to one or more users operating the disclosed interfaces 1400-1650 (FIGS. 14-16). Referring now to FIG. 14, interface 1410 may be included, as depicted in FIG. 14 as a home screen. Interface 1400 may include navigation tools 1411 and 1421, and a multimedia viewing area 1410. The interface may include, among other things, an email tool 1412, which may provide a link to an email client. Interface 1420 depicts a beverage selection screen that may be enabled via selectable icon 1422. Other user-selectable icons may be included, such as a recommendations tool 1423, a filter tool 1424 (depicted as interface 1420), a gift tool 1425 and a responsibility took (depicted as interface 1650).

User interface 1420 may include a filter 1429 for providing a drink recommendation in accordance with discloses embodiments. Accordingly, a plurality of user-selectable drink attribute tools 1429 may be configured to receive user input corresponding to desired drink attributes. A processor of client 237 may receive the user input, store the data corresponding to the input to a memory, and determine one or more beverages for recommendation according to disclosed embodiments herein.

According to some embodiments, interface 1420 may include user-selectable filter lock buttons 1428, which may lock or unlock each respective attribute list 1429. For example, if the locks shown in 1428 as “unlocked” are selected, they may toggle to “lock”, and vice-versa. An unlocked button allows the series of beverage attributes above to be user selectable by sliding, scrolling, selecting, etc. A locked attribute maintains the selected attribute while the unlocked attributes may be changed. As shown in interface 1420 “SWEET” is locked, and will not change, whereas “VODKA” and “COCKTAIL” may be changed. A user selectable “Filter” tool 1427 may be actuated to execute the beverage filter tool. Accordingly, client 237 may provide a beverage recommendation according to the selected attributes 1429. Interface 1430 depicts the results of the a filtered recommendation shown as an example in interface 1420.

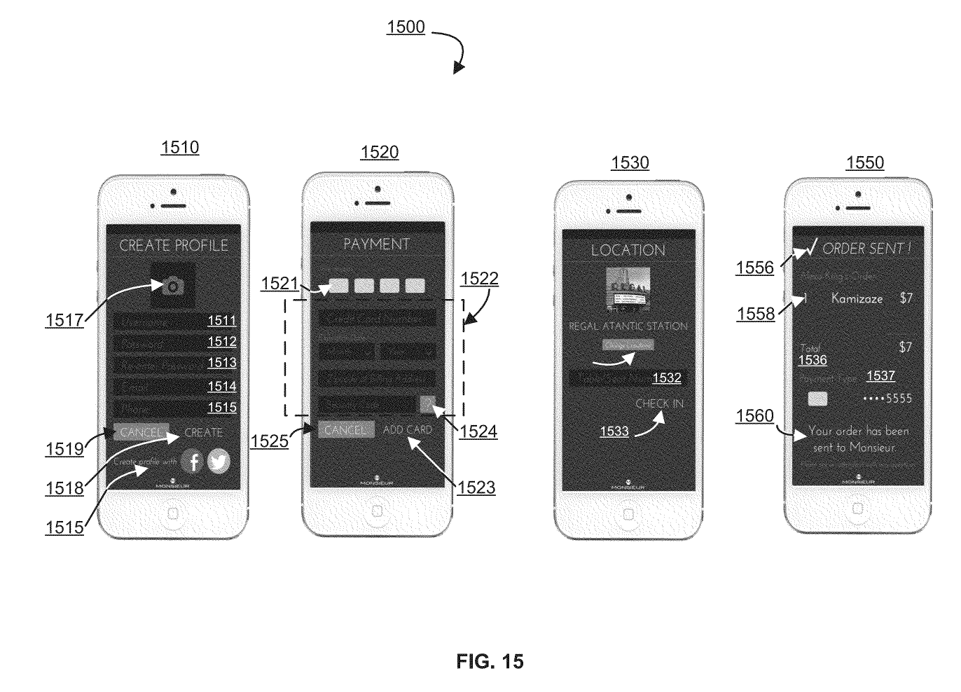

Looking now at FIG. 15, interfaces 1510 and 1520 depict an exemplary user profile creation tool. Control buttons 1518 and 1519 may cancel or create the creation of the user profile, respectively. A photograph tool control button 1517 may receive input that executes a camera associated with exemplary client device 237. Accordingly, photograph data may be stored as part of user/application data 221. Data entry fields 1511-1515 may receive user input for user data, which may then be stored to a local and/or remote memory. User-selectable buttons 1515 may provide access to automatic profile creation via one or more social media platforms.

Interface 1520 depicts a profile creation screen where a processor of client 237 may provide data fields to receive payment information 1521 and 1522. Control buttons 1523-1525 may provide interface control such as, for example, “add card,” “cancel,” and “ask a question,” respectively.

Interface 1530 depicts an exemplary interface for “checking in” at an establishment using one or more automatic beverage dispensers, where the establishment employs a mobile “check-in” system. Checking in may provide notice to an establishment that a user is on the premises, and provide an indication of the physical location of the user (table, section, etc.). Accordingly, user-selectable control buttons 1531, 1532, and 1533 may receive user input that registers a particular user with the establishment employing the location check-in system. Client device 237 may receive user input including data reading table/seat number, etc., and save data representing the user input to a local memory. Accordingly, client device 237 may transmit the data to one or more of server 234, client 233, and/or an operatively connected beverage dispenser 200, etc. The receiving controller may take one or more actions in connection with providing a beverage in response to the received data.

Interface 1550 depicts an exemplary order interface. For example, interface 1550 may include a beverage type, number, and price 1558, an order total 1536, payment information 1537, and/or a message 1560.

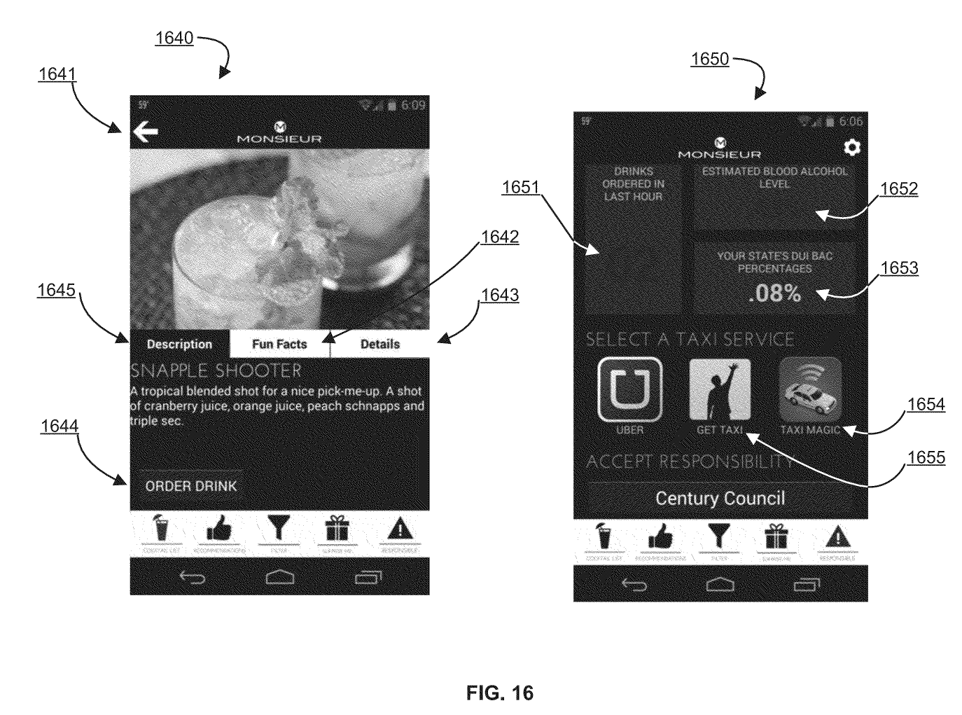

Referring now to FIG. 16, an exemplary user interface is depicted. Interface 1640 may provide a detail page for a particular beverage. Interface 1640 may include a navigation tool 1641, a multimedia selection tool 1642, a beverage detail selection tool 1643, a beverage description selection tool 1645, and an order drink selection tool 1644.

Interface 1650 depicts an exemplary interface for interaction with the intoxication gateway module 222. According to some embodiments, interface 1650 may display a number of drinks ordered within a pre-determined period of time 1651, an estimated blood alcohol level indicator 1652, geographic-specific intoxication rule information 1653, and taxi order service tools 1654.

It is intended that the disclosure and examples be considered as exemplary only, with a true scope and spirit of disclosed embodiments being indicated by the following claims.

What is claimed is:

1. A computer-implemented method for controlling a remotely located beverage dispenser, comprising:
receiving, via a transceiver, first data indicating a status of the remotely located beverage dispenser;
transmitting, via the transceiver, to the remotely located beverage dispenser, instructions that cause the remotely located beverage dispenser to perform at least one of:
modifying the types of beverages servable by the remotely located beverage dispenser;
displaying a pre-determined message via an output device operatively connected to the remotely located beverage dispenser; and
performing a pre-determined shut-down procedure of the remotely located beverage dispenser.

2. The computer-implemented method of claim 1, wherein transmitting the instructions further cause the remotely located beverage dispenser to pump a first liquid ingredient associated with a first pump mechanism through a first sub-nozzle at a first flow velocity, and to pump a second liquid ingredient associated with a second pump mechanism through a second sub-nozzle at a second flow velocity different from the first flow velocity.

3. The computer-implemented method of claim 1, wherein transmitting the instructions further cause the remotely located beverage dispenser to pump a plurality of liquid ingredients through a plurality of sub-nozzles of a nozzle, wherein each sub-nozzle receives only one of the plurality of liquid ingredients.

4. The computer-implemented method of claim 1, wherein transmitting the instructions further cause the remotely located beverage dispenser to perform a beverage recipe sharing operation comprising authenticating a first user client device and receiving, from the authenticated first user client device, instructions for preparing a custom beverage from the first user client device.

5. The computer-implemented method of claim 1, wherein transmitting the instructions further cause the remotely located beverage dispenser to authenticate a first user client device and, based on the authentication, display a pre-determined advertising message.

6. The computer-implemented method of claim 1, wherein transmitting the instructions further cause the remotely located beverage dispenser to maintain at least one module located within a housing of the remotely located beverage dispenser at a refrigerated temperature.

7. The computer-implemented method of claim 1, wherein transmitting the instructions further cause the remotely located beverage dispenser to pump a first liquid ingredient associated with a first pump mechanism through a first sub-nozzle at a first flow velocity and to change the first flow velocity while dispensing a beverage.

8. The computer-implemented method of claim 1, wherein transmitting the instructions further cause the remotely located beverage dispenser to dispense one or more solid ingredients.

9. The computer-implemented method of claim 8, wherein the one or more solid ingredients comprise pickled olives, pickled onions, cherries, citrus wedges, ice, or a combination thereof.

10. A non-transitory computer-readable storage medium storing instructions configured to, when executed, cause one or more processors to perform a method, comprising:
receiving first data indicating a status of the remotely located beverage dispenser;
transmitting, to the remotely located beverage dispenser, instructions that cause the remotely located beverage dispenser to perform at least one of:
modifying the types of beverages servable by the remotely located beverage dispenser;
displaying a pre-determined message via an output device operatively connected to the remotely located beverage dispenser; and
performing a pre-determined shut-down procedure of the remotely located beverage dispenser.

11. The non-transitory computer-readable storage medium of claim 10, wherein the transmitted instructions further cause the remotely located beverage dispenser to pump a first liquid ingredient associated with a first pump mechanism through a first sub-nozzle at a first flow velocity, and to pump a second liquid ingredient associated with a second pump mechanism through a second sub-nozzle at a second flow velocity different from the first flow velocity.

12. The non-transitory computer-readable storage medium of claim 10, wherein the transmitted instructions further cause the remotely located beverage dispenser to pump a first liquid ingredient associated with a first pump mechanism through a first sub-nozzle at a first flow velocity and to change the first flow velocity while dispensing a beverage.

13. The non-transitory computer-readable storage medium of claim 10, wherein the transmitted instructions further cause the remotely located beverage dispenser to pump a plurality of liquid ingredients through a plurality of sub-nozzles of a nozzle, wherein each sub-nozzle receives only one of the plurality of liquid ingredients.

14. The non-transitory computer-readable storage medium of claim 10, wherein the transmitted instructions further cause the remotely located beverage dispenser to perform a beverage recipe sharing operation comprising authenticating a first user client device and receiving, from the authenticated first user client device, instructions for preparing a custom beverage from the first user client device.

15. The non-transitory computer-readable storage medium of claim 10, wherein the transmitted instructions further cause the remotely located beverage dispenser to authenticate a first user client device and, based on the authentication, display a pre-determined advertising message.

16. The non-transitory computer-readable storage medium of claim 10, wherein the transmitted instructions further cause the remotely located beverage dispenser to maintain at least one module located within a housing of the remotely located beverage dispenser at a refrigerated temperature.

17. The non-transitory computer-readable storage medium of claim 10, wherein the transmitted instructions further cause the remotely located beverage dispenser to dispense one or more solid ingredients.

18. A system for controlling a remotely located beverage dispenser, comprising:
at least one memory device storing computer-executable instructions; and
at least one processor configured to execute the stored instructions to:
receive, via a transceiver, first data indicating a status of the remotely located beverage dispenser;
transmit, via the transceiver, to the remotely located beverage dispenser, instructions that cause the remotely located beverage dispenser to perform at least one of:
modifying the types of beverages servable by the remotely located beverage dispenser;
displaying a pre-determined message via an output device operatively connected to the remotely located beverage dispenser; and
performing a pre-determined shut-down procedure of the remotely located beverage dispenser.

19. The system of claim 18, wherein the transmitted instructions further cause the remotely located beverage dispenser to pump a first liquid ingredient associated with a first pump mechanism through a first sub-nozzle at a first flow velocity, and to pump a second liquid ingredient associated with a second pump mechanism through a second sub-nozzle at a second flow velocity different from the first flow velocity.

20. The system of claim 18, wherein the transmitted instructions further cause the remotely located beverage dispenser to pump a plurality of liquid ingredients through a plurality of sub-nozzles of a nozzle, wherein each sub-nozzle receives only one of the plurality of liquid ingredients.
